(19) United States
(12) Patent Application Publication
(10) Pub. No.: US 2025/0080313 A1
(43) Pub. Date: Mar. 6, 2025

(54) RANDOM ACCESS OCCASIONS FOR FULL-DUPLEX CAPABLE WIRELESS DEVICES

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US); Wanshi CHEN, San Diego, CA (US)

(21) Appl. No.: 18/460,396

(22) Filed: Sep. 1, 2023

(51) Int. Cl. H04L 5/14; H04W 74/08

(52) U.S. Cl. CPC H04L 5/14; H04W 74/0833; H04W 74/0891

(57) ABSTRACT

Methods, systems, and devices for wireless communications are described. A network entity may transmit a set of synchronization signal blocks (SSBs) to a user equipment (UE). The set of SSBs may indicate both a first set of random access occasions and a second set of random access occasions that may be different than the first set of random access occasions. The second set of random access occasions may be associated with full-duplex capable wireless devices (e.g., UEs). As such, the network entity may monitor both the first set of random access occasions and the second set of random access occasions. Based on the monitoring, the network entity may receive a random access preamble from a UE during a random access occasion. The UE may transmit the random access preamble during the random access occasion based on the UE being a full-duplex capable wireless device.

### FIELD OF TECHNOLOGY

The following relates to wireless communications, including random access occasions for full-duplex capable wireless devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support random access occasions for full-duplex capable wireless devices. For example, the described techniques provide for a network entity to transmit a set of synchronization signal blocks (SSBs) to a user equipment (UE). The set of SSBs may indicate both a first set of random access occasions and a second set of random access occasions that may be different than the first set of random access occasions. The second set of random access occasions may be associated with full-duplex capable wireless devices (e.g., UEs). As such, the network entity may monitor both the first set of random access occasions and the second set of random access occasions. Based on the monitoring, the network entity may receive a random access preamble from a UE during a random access occasion. The UE may transmit the random access preamble during the random access occasion based on the UE being a full-duplex capable wireless device.

A method for wireless communications by a network entity is described. The method may include transmitting a set of SSBs that indicate both a first set of random access occasions and a second set of random access occasions different from the first set of random access occasions, the second set of random access occasions associated with full duplex capable wireless devices, monitoring both the first set of random access occasions and the second set of random access occasions, and receiving, from a UE during a random access occasion, a random access preamble based on the UE being a full-duplex capable wireless device and based on the monitoring of the first set of random access occasions and the second set of random access occasions.

A network entity for wireless communications is described. The network entity may include one or more memories storing processor executable code, and one or more processors coupled with the one or more memories. The one or more processors may individually or collectively operable to execute the code to cause the network entity to transmit a set of SSBs that indicate both a first set of random access occasions and a second set of random access occasions different from the first set of random access occasions, the second set of random access occasions associated with full duplex capable wireless devices, monitor both the first set of random access occasions and the second set of random access occasions, and receive, from a UE during a random access occasion, a random access preamble based on the UE being a full-duplex capable wireless device and based on the monitoring of the first set of random access occasions and the second set of random access occasions.

Another network entity for wireless communications is described. The network entity may include means for transmitting a set of SSBs that indicate both a first set of random access occasions and a second set of random access occasions different from the first set of random access occasions, the second set of random access occasions associated with full duplex capable wireless devices, means for monitoring both the first set of random access occasions and the second set of random access occasions, and means for receiving, from a UE during a random access occasion, a random access preamble based on the UE being a full-duplex capable wireless device and based on the monitoring of the first set of random access occasions and the second set of random access occasions.

A non-transitory computer-readable medium storing code for wireless communications is described. The code may include instructions executable by a processor to transmit a set of SSBs that indicate both a first set of random access occasions and a second set of random access occasions different from the first set of random access occasions, the second set of random access occasions associated with full duplex capable wireless devices, monitor both the first set of random access occasions and the second set of random access occasions, and receive, from a UE during a random access occasion, a random access preamble based on the UE being a full-duplex capable wireless device and based on the monitoring of the first set of random access occasions and the second set of random access occasions.

In some examples of the method, network entities, and non-transitory computer-readable medium described herein, transmitting the set of SSBs may include operations, features, means, or instructions for transmitting system information that indicates the second set of random access occasions associated with the full-duplex capable wireless devices, the system information being transmitted as part of the set of SSBs.

Some examples of the method, network entities, and non-transitory computer-readable medium described herein may further include operations, features, means, or instructions for transmitting system information that indicates the random access occasion for the full-duplex capable wireless devices to use for transmission of random access preamble transmission, where the random access preamble may be received from the UE via the random access occasion indicated by the system information.

In some examples of the method, network entities, and non-transitory computer-readable medium described herein, receiving the random access preamble may include operations, features, means, or instructions for receiving, from the UE, the random access preamble during the random access occasion, where the random access occasion may be of the first set of random access occasions or of the second set of random access occasions.

In some examples of the method, network entities, and non-transitory computer-readable medium described herein, transmitting the set of SSBs may include operations, features, means, or instructions for transmitting the set of SSBs that indicate the first set of random access occasions and the second set of random access occasions, where the second set of random access occasions may be offset from the first set of random access occasions in accordance with a time offset, a frequency offset, or both.

Some examples of the method, network entities, and non-transitory computer-readable medium described herein may further include operations, features, means, or instructions for transmitting system information that indicates the time offset, the frequency offset, or both.

In some examples of the method, network entities, and non-transitory computer-readable medium described herein, receiving the random access preamble may include operations, features, means, or instructions for receiving, during the random access occasion of the second set of random access occasions, the random access preamble from a first set of random access preambles associated with the full-duplex capable wireless devices, where the first set of random access preambles may be the same or different from a second set of random access preambles associated with half-duplex wireless devices.

Some examples of the method, network entities, and non-transitory computer-readable medium described herein may further include operations, features, means, or instructions for receiving, from the UE, the random access preamble via one or more symbols of a slot within the random access occasion of the second set of random access occasions and in accordance with a set of validity rules, where the set of validity rules indicate that the slot may be valid based on a quantity of symbols after transmission of a SSB of the set of SSBs and a communication direction associated with the slot.

Some examples of the method, network entities, and non-transitory computer-readable medium described herein may further include operations, features, means, or instructions for receiving, from the UE, the random access preamble via one or more symbols of a slot within the random access occasion of the second set of random access occasions and in accordance with a set of validity rules, where the set of validity rules indicate that the slot may be valid based on a quantity of symbols after transmission of a SSB of the set of SSBs, a communication direction associated with the slot, and whether the slot of the random access occasion may be within an uplink sub-band on a full-duplex slot.

In some examples of the method, network entities, and non-transitory computer-readable medium described herein, the first set of random access occasions may be indicated by the set of SSBs and a first mapping between the set of SSBs and the first set of random access occasions, and where the second set of random access occasions may be indicated by the set of SSBs and a second mapping between the set of SSBs and the second set of random access occasions.

A method for wireless communications by a UE is described. The method may include receiving one or more SSBs that indicate both a first set of random access occasions and a second set of random access occasions different from the first set of random access occasions, the second set of random access occasions associated with full-duplex capable wireless devices and transmitting, to a network entity, during a random access occasion, a random access preamble based on the UE being a full-duplex capable wireless device and based on receiving the one or more SSBs indicating the first set of random access occasions and the second set of random access occasions.

A UE for wireless communications is described. The UE may include one or more memories storing processor executable code, and one or more processors coupled with the one or more memories. The one or more processors may individually or collectively operable to execute the code to cause the UE to receive one or more SSBs that indicate both a first set of random access occasions and a second set of random access occasions different from the first set of random access occasions, the second set of random access occasions associated with full-duplex capable wireless devices and transmit, to a network entity, during a random access occasion, a random access preamble based on the UE being a full-duplex capable wireless device and based on receiving the one or more SSBs indicating the first set of random access occasions and the second set of random access occasions.

Another UE for wireless communications is described. The UE may include means for receiving one or more SSBs that indicate both a first set of random access occasions and a second set of random access occasions different from the first set of random access occasions, the second set of random access occasions associated with full-duplex capable wireless devices and means for transmitting, to a network entity, during a random access occasion, a random access preamble based on the UE being a full-duplex capable wireless device and based on receiving the one or more SSBs indicating the first set of random access occasions and the second set of random access occasions.

A non-transitory computer-readable medium storing code for wireless communications is described. The code may include instructions executable by a processor to receive one or more SSBs that indicate both a first set of random access occasions and a second set of random access occasions different from the first set of random access occasions, the second set of random access occasions associated with full-duplex capable wireless devices and transmit, to a network entity, during a random access occasion, a random access preamble based on the UE being a full-duplex capable wireless device and based on receiving the one or more SSBs indicating the first set of random access occasions and the second set of random access occasions.

In some examples of the method, UEs, and non-transitory computer-readable medium described herein, receiving the one or more SSBs may include operations, features, means, or instructions for receiving, from the network entity, system information that indicates the second set of random access occasions associated with the full-duplex capable wireless devices, the system information being received based on receiving of the one or more SSBs.

Some examples of the method, UEs, and non-transitory computer-readable medium described herein may further include operations, features, means, or instructions for receiving, from the network entity, system information that indicates a random access occasion of for the UE to use for transmission, where the random access preamble may be transmitted to the network entity via the random access occasion indicated by the system information.

In some examples of the method, UEs, and non-transitory computer-readable medium described herein, transmitting the random access preamble may include operations, features, means, or instructions for transmitting the random access preamble during the random access occasion, where the random access occasion may be of the first set of random access occasions or of the second set of random access occasions.

In some examples of the method, UEs, and non-transitory computer-readable medium described herein, receiving the one or more SSBs may include operations, features, means, or instructions for receiving the one or more SSBs that indicate the first set of random access occasions and the second set of random access occasions, where the second set of random access occasions may be offset from the first set of random access occasions in accordance with a time offset, a frequency offset, or both.

In some examples of the method, UEs, and non-transitory computer-readable medium described herein, the second set of random access occasions may be offset from the first set of random access occasions and the method, apparatuses, and non-transitory computer-readable medium may include further operations, features, means, or instructions for receiving, from the network entity, system information that indicates the time offset, the frequency offset, or both.

In some examples of the method, UEs, and non-transitory computer-readable medium described herein, transmitting the random access preamble may include operations, features, means, or instructions for transmitting, during the random access occasion of the second set of random access occasions, the random access preamble from a first set of random access preambles associated with the full-duplex capable wireless devices, where the first set of random access preambles may be the same or different from a second set of random access preambles associated with half-duplex wireless devices.

Some examples of the method, UEs, and non-transitory computer-readable medium described herein may further include operations, features, means, or instructions for transmitting, to the network entity, the random access preamble via one or more symbols of a slot within the random access occasion the second set of random access occasions and in accordance with a set of validity rules, where the set of validity rules indicate that the slot may be valid based on a quantity of symbols after reception of a SSB of the one or more SSBs and a communication direction associated with the slot.

Some examples of the method, UEs, and non-transitory computer-readable medium described herein may further include operations, features, means, or instructions for transmitting, to the network entity, the random access preamble via one or more symbols of a slot within the random access occasion of the second set of random access occasions and in accordance with a set of validity rules, where the set of validity rules indicate that the slot may be valid based on a quantity of symbols after reception of a SSB of the one or more SSBs, a communication direction associated with the slot, and whether the slot of the random access occasion may be within an uplink sub-band of a full-duplex slot.

In some examples of the method, UEs, and non-transitory computer-readable medium described herein, the first set of random access occasions may be indicated by the one or more SSBs and a first mapping between the one or more of SSBs and the first set of random access occasions, and where the second set of random access occasions may be indicated by the one or more of synchronization blocks and a second mapping between the one or more of SSBs and the second set of random access occasions.

### BRIEF DESCRIPTION OF THE DRAWINGS

FIG. 1 shows an example of a wireless communications system that supports random access occasions for full-duplex capable wireless devices in accordance with one or more aspects of the present disclosure.

FIG. 2 shows an example of a wireless communications system that supports random access occasions for full-duplex capable wireless devices in accordance with one or more aspects of the present disclosure.

FIG. 3 shows an example of a resource allocation diagram that supports random access occasions for full-duplex capable wireless devices in accordance with one or more aspects of the present disclosure.

FIG. 4 shows an example of a resource timeline that supports random access occasions for full-duplex capable wireless devices in accordance with one or more aspects of the present disclosure.

FIG. 5 shows an example of a process flow that supports random access occasions for full-duplex capable wireless devices in accordance with one or more aspects of the present disclosure.

FIGS. 6 and 7 show block diagrams of devices that support random access occasions for full-duplex capable wireless devices in accordance with one or more aspects of the present disclosure.

FIG. 8 shows a block diagram of a communications manager that supports random access occasions for full-duplex capable wireless devices in accordance with one or more aspects of the present disclosure.

FIG. 9 shows a diagram of a system including a device that supports random access occasions for full-duplex capable wireless devices in accordance with one or more aspects of the present disclosure.

FIGS. 10 and 11 show block diagrams of devices that support random access occasions for full-duplex capable wireless devices in accordance with one or more aspects of the present disclosure.

FIG. 12 shows a block diagram of a communications manager that supports random access occasions for full-duplex capable wireless devices in accordance with one or more aspects of the present disclosure.

FIG. 13 shows a diagram of a system including a device that supports random access occasions for full-duplex capable wireless devices in accordance with one or more aspects of the present disclosure.

FIGS. 14 through 18 show flowcharts illustrating methods that support random access occasions for full-duplex capable wireless devices in accordance with one or more aspects of the present disclosure.

### DETAILED DESCRIPTION

In some wireless communication systems, a user equipment (UE) may support full-duplex communications and be able to transmit and receive signals at the same time (e.g., using overlapping time/frequency resources). In some examples, a wireless communications system may support full-duplex slots in addition to uplink and downlink slots. A full-duplex slot may include an uplink sub-band and a downlink sub-band, which may support full-duplex communications (e.g., transmission and reception) during the full-duplex slot for full-duplex capable wireless devices. A UE may receive one or more synchronization signal blocks (SSBs) from a network entity which are associated with, or may be indicative of, a set of random access occasions (e.g., random access channel (RACH) occasions). Based on receiving the one or more SSBs, the UE may transmit a random access preamble via a random access occasion of the set of random access occasions. However, when the network entity allocates random access occasions for a full-duplex UE, some random access occasions may be allocated within a downlink sub-band of a full-duplex slot. For example, the resources for the UE to transmit a random access preamble, which is an uplink transmission, may be within the downlink sub-band of the full-duplex slot, and the UE may not support using the downlink sub-band for an uplink transmission. In this example, the random access occasion may be an invalid random access occasion. Invalid random access occasions may increase the latency of communications between the UE and the network entity, thus decreasing the reliability of the wireless communication system. For example, by being allocated an invalid random access occasion, the UE may have to wait for an indication of another set of random access occasions or the UE may have to wait to use an alternative random access occasion already allocated, either of which would therefore increase the latency within the wireless communications system.

Wireless communications systems described herein may support random access occasions that are associated with or configured based on full-duplex communications. A network entity may transmit a set of SSBs that are indicative of a first set of random access occasions for half-duplex UEs. In some examples, the set of SSBs may be indicative of a second set of random access occasions for full-duplex UEs. In some examples, the second set of random access occasions may be different from the first set of random access occasions. In some examples, of the network entity may transmit a system information block (SIB) to indicate the first set of random access occasions or the second set of random access occasions, or both. In some examples, the SIB may indicate or define resource allocations for the second set of random access occasions. Additionally, or alternatively, the second set of random access occasions may be associated with the first set of random access occasions, such as by being offset from the first set of random access occasions in the time domain or frequency domain, or both. In some examples, the UE may determine whether to transmit a random access preamble via a random access occasion from the first set of random access occasions or a random access occasion from the second set of random access occasions. For example, the SIB may indicate whether the UE is to transmit the random access preamble via a random access occasion in the first set of random access occasions or the second set of random access occasions, or whether the UE may use a random access occasion from either set. The network entity may monitor for the random access preamble from the UE in the first set of random access occasions or the second set of random access occasions, or both. Based on receiving the random access preamble, the network entity may schedule subsequent communications using the resources that transmitted the SSB associated with the random access occasion that the UE used to transmit the random access preamble. As such, the techniques described herein may ensure that full-duplex UEs receive valid RACH occasion configurations to enhance the reliability of the wireless communications system.

Aspects of the disclosure are initially described in the context of wireless communications systems. Additional aspects of the disclosure are described herein with reference to wireless communications systems, a resource allocation diagram, a resource timeline, and a process flow. Aspects of the disclosure are further illustrated by and described with reference to apparatus diagrams, system diagrams, and flowcharts that relate to random access occasions for full-duplex capable wireless devices.

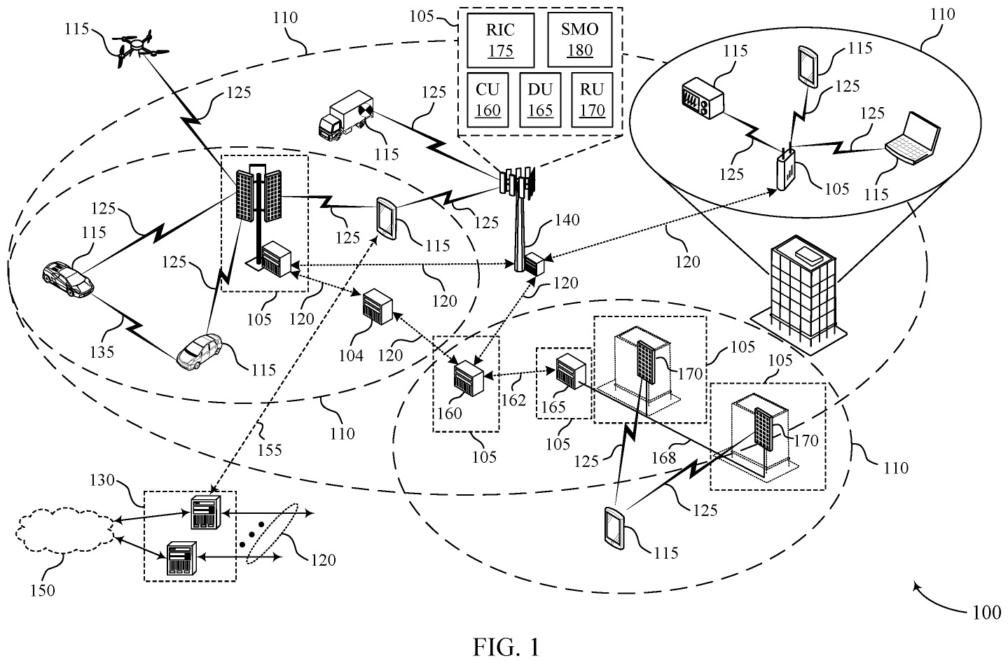

FIG. 1 shows an example of a wireless communications system 100 that supports random access occasions for full-duplex capable wireless devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support random access occasions for full-duplex capable wireless devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, UEs 115 may support full-duplex communications and be able to transmit and receive signals at the same time (e.g., using overlapping time/frequency resources). In some examples, the wireless communications system 100 may support full-duplex slots in addition to uplink and downlink slots. A full-duplex slot may include an uplink sub-band and a downlink sub-band, which may support full-duplex communications (e.g., transmission and reception) during the full-duplex slot for full-duplex capable wireless devices. A UE 115 may receive one or more SSBs from a network entity 105 which are associated with, or may be indicative of a set of random access occasions (e.g., RACH occasions). Based on receiving the sone or more SSBs, the UE 115 may transmit a random access preamble via a random access occasion of the set of random access occasions. However, when the network entity 105 allocates random access occasions for a full-duplex UE 115, some random access occasions may be allocated within a downlink sub-band of a full-duplex slot. For example, the resources for the UE 115 to transmit a random access preamble, which is an uplink transmission, may be within the downlink sub-band of a full-duplex slot and the UE may not support using the downlink sub-band for an uplink transmission. In this example, the random access occasion may be an invalid random access occasion. Invalid random access occasions may increase the latency of communications between the UE 115 and the network entity 105, thus decreasing the reliability of the wireless communications system 100. For example, by being allocated an invalid random access occasion, the UE may have to wait for an indication of another set of random access occasions or the UE may have to wait to use an alternative random access occasion already allocated, either of which would therefore increase the latency within the wireless communications system.

In some examples, one or more SSBs may be indicative of a set of random access occasions for the UE 115 to use for transmitting a random access preamble. In some cases, when the UE 115 is a full-duplex UE 115, some of the random access occasions may fall on full-duplex slots. Full-duplex slots may be split between uplink and downlink sub-bands such that the UE 115 may be capable of transmitting and receiving signals at the same time using overlapping resources. However, in some examples, a random access occasion may fall within a downlink sub-band of the full-duplex slot. As the UE 115 may transmit the random access preamble via the uplink communication link, having a random access occasion within downlink resources may be invalid. As such, some random access occasions may be invalid which may limit the quantity of valid random access occasions that the UE 115 may be capable of using. Moreover, by limiting the quantity of valid random access occasions, additional latency may be introduced and the reliability of the wireless communications system 100 may decrease.

As such, wireless communications systems described herein may support random access occasions that are associated with or configured based on full-duplex communications. A network entity 105 may transmit a set of SSBs that are indicative of a first set of random access occasions for half-duplex UEs 115.In some examples, the set of SSBs may be indicative of a second set of random access occasions for full-duplex UEs 115. In some cases, the second set of random access occasions may be different from the first set of random access occasions. In some examples, the network entity 105 may transmit a SIB to indicate the first set of random access occasions, the second set of random access occasions, or both. In some examples, the SIB may indicate or define resource allocations for the second set of random access occasions.

Additionally, or alternatively, the second set of random access occasions may be associated with the first set of random access occasions, such as by being offset from the first set of random access occasions in the time domain or frequency domain, or both. In some examples, the UE 115 may determine whether to transmit a random access preamble via a random access occasion from the first set of random access occasions or via a random access occasion from the second set of random access occasions. For example, the SIB may indicate whether the UE is to transmit the random access preamble via a random access occasion in the first set of random access occasions or the second set of random access occasions, or whether the UE may use a random access occasion from either set. The network entity 105 may monitor for the random access preamble from the UE 115 in the first set of random access occasions, the second set of random access occasions, or both. Based on receiving the random access preamble, the network entity 105 may schedule subsequent communications using the resources that transmitted the SSB associated with the random access occasion that the UE 115 used to transmit the random access preamble. As such, the techniques described herein may ensure that full-duplex UEs 115 receive valid RACH occasion configurations to enhance the reliability of the wireless communications system 100.

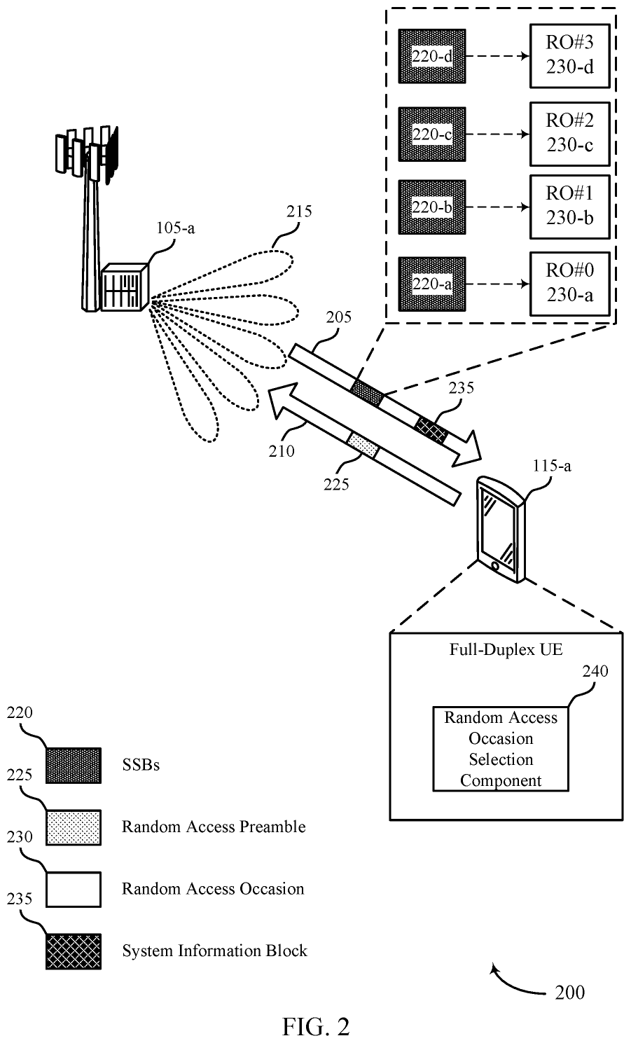

FIG. 2 shows an example of a wireless communications system 200 that supports random access occasions for full-duplex capable wireless devices in accordance with one or more aspects of the present disclosure. In some examples, the wireless communications system 200 may implement or be implemented by the wireless communications system 100. For example, the wireless communications system 200 may include a UE 115-a and a network entity 105-a The UE 115-a and the network entity 105-a may communicate via a downlink communication link 205 and an uplink communication link 210, which may be examples of a communication link 125 described with reference to FIG. 1. In some cases, the network entity 105-a may communicate with the UE 115-a via the downlink communication link 205 via a set of beams 215. The downlink communication link 205 and the uplink communication link 210 may be examples of a Uu link, a sidelink, a backhaul link, a D2D link, or some other type of communication link 125 described herein with reference to FIG. 1.

In some examples, the UE 115-a may be an example of a full-duplex UE 115. That is, the UE 115-a may be able to both transmit and receive signals or messages at the same time. As such, the UE 115-a may transmit and receive signals using overlapping uplink and downlink resources in the time domain, while a half-duplex UE 115 may only support either transmitting signals or receiving signals during overlapping uplink and downlink resources in the time domain.

In some cases, the network entity 105-a may transmit a set of SSBs 220 via the set of beams 215 via the downlink communication link to the UE 115-a. In some examples, the set of SSBs 220 may be associated with, or mapped to, a set of random access occasions 230 for the UE 115-a to transmit a random access preamble 225 via the uplink communication link 210. In some other cases, a first SSB from the set of SSBs 220 may be associated with multiple random access occasions (e.g., four random access occasions) from the set of random access occasions 230. For example, an SSB 220-a received at a first frequency may correspond to random access occasion 230-a, an SSB 220-b received at a second frequency may correspond to random access occasion 230-b, an SSB 220-c received at a third frequency may correspond to random access occasion 230-c, and an SSB 220-d received at a fourth frequency may correspond to random access occasion 230-d. In some examples, different SSBs may correspond to different random access occasions. For example, a first SSB received via a beam with a first SSB index may correspond to, or be mapped to, a first random access occasion, and a second SSB received via a second beam with a second SSB index may correspond to, or be mapped to, a second random access occasion. In some examples, the network entity 105-a may transmit the set of SSBs 220 via the set of beams 215 and each respective SSB 220 of the set of SSBs 220 transmitted via each respective beam 215 of the set of beams 215 may be associated with or correspond to a random access occasion 230. Additionally, or alternatively, a single SSB 220 may be associated with one or more random access occasions 230 of a set of random access occasions.

For a first type of random access procedure (e.g., type-1 random access procedure), the UE 115-a may be provided with a quantity, N, of SSBs/physical broadcast channel (PBCH) block indexes associated with one or more PRACH occasions. The UE 115-a may also be provided with a quantity, R, of contention based preambles per each SSB/PBCH block index per valid PRACH occasion (e.g., the UE 115-a may be provided by a ssb-perRACH-OccasionAndCB-PreamblesPerSSB). The ssb-perRACH-OccasionAndCB-PreamblesPerSSB may be a field of Rach-ConfigCommon and may include a choice. The choice parameter may convey a quantity of SSBs per RACH occasion. For example, a value of oneEighth may correspond to one SSB being associated with eight RACH occasions and a value of oneFourth may correspond to one SSB being associated with four RACH occasions. The options for the choice may also be indicated as being enumerated. The enumerated part may indicate the quantity of contention based preambles per SSB. For example, a value of n4 may correspond to four contention based preambles per SSB and a value of n8 may correspond to eight contention based preambles per SSB. Further, the total quantity of contention based preambles in a RACH occasion may be indicated by CB-preambles-per-SSB*max (1, SSB-per-rach-occasion).

For the first type of random access procedure or a second type of random access procedure (e.g., type-2 random access procedure) with a separate configuration of PRACH occasions than the configuration of the PRACH occasions of the first type of random access procedure, if N<1 than one SSB/PBCH block index may be mapped to 1/N consecutive valid PRACH occasions. Further, R contention based preambles with consecutive indexes associated with the SSB/PBCH block index per valid PRACH occasions may start from preamble index zero (e.g., the first preamble index). If N≥1, R contention based preambles with consecutive indexes associated with the SSB/PBCH block index n, 0≤n≤N−1, per valid PRACH occasion may start from preamble index n*N_{preamble}^{total}/n (e.g., Ntotal may be provided by totalNumberOfRA-Preambles for the first type of random access procedure).

In some examples, the SSB/PBCH block indexes may be provided by a SIB 235 or via a configuration (e.g., by ssb-PositionsInBurst in SIB1 or in ServingCellConfig ('ommon) and the indexes may be mapped to valid PRACH occasions according to an order. For example, first, the indexes may be mapped in an increasing order of preamble indexes within a single PRACH occasion. Second, the indexes may be mapped in an increasing order of frequency resource indexes for frequency multiplexed PRACH occasions. Third, the indexes may be mapped in an increasing order of time resource indexes for time multiplexed PRACH resources within a PRACH slot. Finally, the indexes may be mapped in an increasing order of indexes for PRACH slots.

In some cases, when SSBs may be associated with RACH occasions, such associations may be indicated differently. For example, as illustrated, the network entity 105-a may transmit the set of SSBs 220 via the set of beams 215 and the set of SSBs 220 may be associated with a set of random access occasions 230 (e.g., a set of RACH occasions). In some cases, the set of random access occasions 230 may be indicated for all the SSBs 220 of the set of SSBs 220 in each sub frame number four (subFN4) and subFN9 with different random access preamble 225 sets. In some other cases, the random access occasion 230 may be provided for each SSB 220 with a periodicity of four SFNs. Additionally, or alternatively, the random access occasion 230 may be provided for a singly SSB 220 in each SFN.

Further, in some examples, there may be a SSB 220 and random access occasion 230 association period and association pattern. An association period, starting from frame zero, for mapping SSB/PBCH block indexes to PRACH occasions may be the smallest value in a set determined by the PRACH configuration period. The association period may be such that N_{Tx}^{SSB} SSB/PBCH block indexes may be mapped at least once to the PRACH occasions within the association period. The UE 115-a may obtain the value of N_{Tx}^{SSB} from the value of the ssb-PositionsInBurst field in SIB1 or in ServingC'ellConfigCommon. In some cases, after an integer quantity of SSB/PBCH block indexes to PRACH occasion mapping cycles within the association period there may be a set of PRACH occasions or PRACH preambles that may remain unmapped to the N_{Tx}^{SSB} SSB/PBCH block indexes. As such, the UE 115-a may refrain from mapping SSB/PBCH block indexes to the set of unmapped PRACH occasions or PRACH preambles. Further, an association period pattern may include one or more association periods and is determined such that a pattern between PRACH occasions and SSB/PBCH block indexes repeat (e.g., at most every 160 milliseconds). Additionally, the UE 115-a may refrain from using any PRACH occasions that remain unassociated with SSB/PBCH block indexes after an integer number of association periods for PRACH transmissions.

As such, the techniques of the present disclosure are used to enhance the reliability of the wireless communications system 200. For example, an additional set of random access occasions 230 may be indicated for the UE 115-a based on the UE 115-a being a full-duplex capable wireless device. the UE 115-a may receive the set of SSBs 220 from the network entity 105-a via the set of beams 215, and the set of SSBs 220 may be indicative of a first set of random access occasions 230. In some examples, the set of SSBs may also be indicative a second set of random access occasions 230 that are different from the first set of random access occasions 230. The second set of random access occasions 230 may be allocated or dedicated for full-duplex capable wireless devices (e.g., UE 115-a). Additionally, or alternatively, by the network entity 105-a indicating the second set of random access occasions, the network entity 105-a may indicate support for the UE 115-a to use full-duplex communications. In some cases, the network entity 105-a may also send a message to the UE 115-a enabling the UE 115-a to use full-duplex communications.

In some examples, the second set of random access occasions 230 may be indicated via a SIB 235. In some cases, the SIB 235 may also indicate the first set of random access occasions 230. Further, the set of SSBs 220 may include a master information block (MIB) which may include information associated with the SIB 235, such as an occasion of the SIB 235 or information for decoding the SIB 235. The UE 115-a may use a random access occasion selection component 240 to select a random access occasion 230 to transmit the random access preamble 225. In some cases, the UE 115-a may select a random access occasion 230 from the first set of random access occasions 230 or from the second set of random access occasions 230 based on the capability of the UE 115-a. For example, if the UE 115-a is a full-duplex capable UE 115, the UE 115-a may be capable of selecting a random access occasion 230 from the first set of random access occasions 230 or from the second set of random access occasions. Additionally, or alternatively, the SIB 235 may indicate whether the UE 115-a is to use a random access occasion 230 from the first set of random access occasions 230 or the second set of random access occasions 230. If the UE 115-a is a half-duplex capable UE 115, the UE 115-a may only be capable of selecting a random access occasion 230 from the first set of random access occasions 230. Further, if the UE 115-a is a half-duplex capable UE 115, the UE 115-a may be unaware of the second set of random access occasions 230 and thus may select random access occasions 230 from the first set of random access occasions 230. Moreover, in some examples, when the UE 115-a is a full-duplex capable UE 115, the network entity 105-a may monitor all the allocated random access occasions 230 for the random access preamble. In some other examples, the network entity 105-a may refrain from monitoring the first set of random access occasions 230 when the UE 115-a is allocated to transmit the random access preamble 225 within the second set of random access occasions

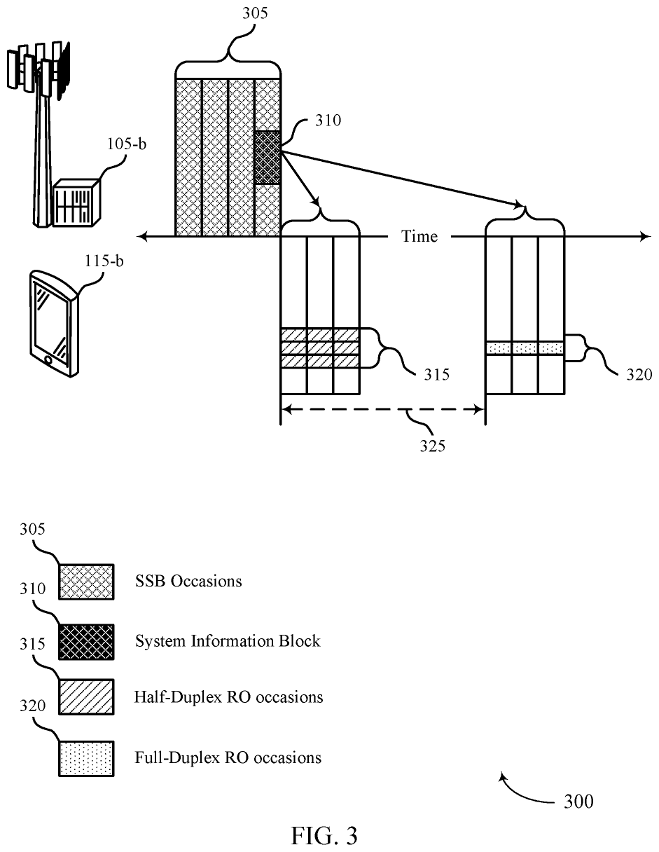

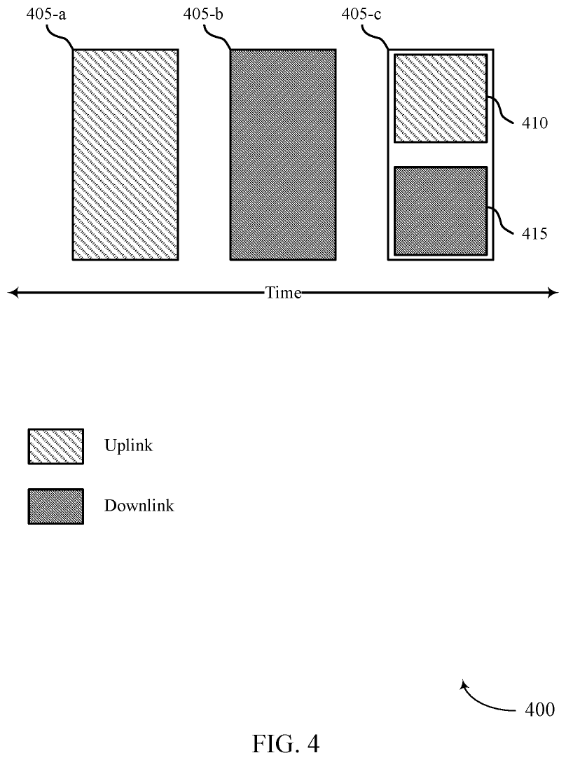

Further description of the network entity 105-a transmitting set of SSBs 220 and the SIB 235 to indicate both the first set of random access occasions and the second set of random access indications may be described with reference to FIG. 3 and the validity of the second set of random access occasions may be described with reference to FIG. 4.

FIG. 3 shows an example of a resource allocation diagram 300 that supports random access occasions for full-duplex capable wireless devices in accordance with one or more aspects of the present disclosure. In some examples, the resource allocation diagram 300 may implement or be implemented by the wireless communications system 100 or the wireless communications system 200. For example, the resource allocation diagram 300 may include a UE 115-b and a network entity 105-b, which may be examples of devices described herein with reference to FIG. 1.

As described herein, the network entity 105-b may transmit a set of SSBs to the UE 115-b during a set of SSB occasions 305 in the time domain. In some cases, the set of SSBs may include a MIB which may include parameters for the UE 115-b to use to decode system information within a SIB 310. As such, the UE 115-b may decode the MIB and store the decoded parameters. Following, the UE 115-b may receive the SIB 310 and decode the SIB 310 using the decoded parameters from the MIB. In some examples, the SIB 310 may be received during an SSB occasion 305 or after the set of SSB occasions 305. The SIB 310 may indicate a first set of random access occasions associated with, allocated for, or dedicated for half-duplex capable wireless devices (e.g., half-duplex random access occasions 315) and a second set of random access occasions associated with, allocated for, or dedicated for full-duplex capable wireless devices (e.g., full-duplex random access occasions 320).

In some examples, the full-duplex random access occasions 320 may be different and offset from the half-duplex random access occasions 315. For example, the full-duplex random access occasions 320 may be indicated, via the SIB 310, as being offset by a time offset 325 from the half-duplex random access occasions. Additionally, or alternatively, the full-duplex random access occasions 320 may also be offset from the half-duplex random access occasions by a frequency offset. Further, the full-duplex random access occasions 320 may follow the same SSB-random access occasion association mapping as the half-duplex random access occasions 315 plus the time offset 325, the frequency offset, or both.

In some cases, the full-duplex random access occasions 320 may be indicated via an independent configuration separate from the indicated on the half-duplex random access occasions 315. The UE 115-b may receive an SSB and identify time and frequency resource information for the full-duplex random access occasions 320 based on a separate SSB-to-resource occasion mapping (e.g., separate from an SSB-to-resource occasion mapping for the half-duplex random access occasions 315). In some examples, the network entity 105-b may transmit separate configurations to indicate the half-duplex random access occasions 315 and the full-duplex random access occasions 320. For example, the network entity 105-b may transmit multiple SIBs 310 or the network entity may transmit the indications via other types of messages (e.g., a downlink control information (DCI) message, a MAC-CE message, an RRC message). In some examples, the UE 115-b may be preconfigured with the full-duplex random access occasions 320, or the SSB-to-resource occasion mapping for the full-duplex random access occasions 320 may be preconfigured for a wireless communications system including the UE 115-b and the network entity 105-b.

After receiving the SIB 310 indicating the half-duplex random access occasions 315 and the full-duplex random access occasions 320, the UE 115-b may select a random access occasion from the half-duplex random access occasions 315 or from the full-duplex random access occasions 320 to use to transmit a random access preamble. In some cases, if the UE 115-b is a full-duplex UE 115, the UE 115-b may only select random access occasions from the full-duplex random access occasions 320. In some other cases, if the UE 115-b is a full-duplex UE 115, the UE 115-b may be capable of selecting a random access occasion from the half-duplex random access occasions 315 or from the full-duplex random access occasions 320. In some examples, the network entity 105-b may indicate which random access occasion the UE 115-b should use via the SIB 310. For example, the SIB 310 may indicate the half-duplex random access occasions 315 or the full-duplex random access occasions 320, or both, and the SIB 310 may indicate whether the UE 115-b is to use a random access occasion from the half-duplex random access occasions 315 or the full-duplex random access occasions 320, or either. In some cases, when transmitting the random access preamble, via the selected or indicated random access occasion, the UE 115-b may transmit the random access preamble from a set of random access preambles.

In some examples, the UE 115-b may be configured with a first set of random access preambles associated with, allocated for, or dedicated for half-duplex communications and a second set of random access preambles associated with, allocated for, or dedicated with full-duplex communications. In some cases, the first set of random access preambles and the second set of random access preambles may be the same or different.

When selecting the random access occasion, the UE 115-b may have to determine that the random access occasion is valid when the random access occasion occurs during a half-duplex slot or during a full-duplex slot. Further description of determining the validation of the random access occasion may be described elsewhere herein including with reference to FIG. 4.

FIG. 4 shows an example of a resource timeline 400 that supports random access occasions for full-duplex capable wireless devices in accordance with one or more aspects of the present disclosure. In some examples, the resource timeline 400 may implement or be implemented by the wireless communications system 100 or the wireless communications system 200. For example, the resource timeline 400 may be used by a UE 115 and a network entity 105, which may be examples of devices described herein with reference to FIG. 1.

In some examples, the UE 115 and the network entity 105 may be configured with slots 405 (e.g., slot 405-a, slot 405-b, slot 405-c) for communicating signals. In some cases, the slot 405-a may be an uplink slot, the slot 405-b may be a downlink slot, and the slot 405-c may be a full-duplex slot. Full-duplex slots may contain both uplink sub-bands and downlink sub-bands. As such, the slot 405-c may contain a first sub-band 410 which may be an uplink sub-band and a second sub-band 415 which may be a downlink sub-band.

When selecting a random access occasion for the UE 115 to transmit a random access preamble the UE 115 may determine whether the random access occasion is valid. In some examples, the UE 115 may use set of validity rules for half-duplex slots that may refrain from considering the sub-band structure of full-duplex slots. For example, for the paired spectrum or supplementary uplink bands, all random access occasions (e.g., PRACH occasions) may be considered valid. For the unpaired spectrum, if the UE 115 is not provided with a time domain common configuration parameter (e.g., tdd-UL-DL-ConfigurationCommon) a random access occasion may be considered valid if the random access occasion does not precede a SSB/PBCH block in the slot 405 of the random access occasion (e.g., PRACH slot) and the slot 405 starts at least N_{gap} symbols after the most recent SSB/PBCH block reception symbol. In some cases, the value of N_{gap} may be provided and may differ based on the subcarrier spacing (SCS) of the random access preamble. For example, if the SCS is 1.25 kilohertz (kHz) or 5 kHz the N_{gap} may be equal to zero, if the SCS is 15 kHz, 30 kHz, 60 kHz, or 120 kHz the value of N_{gap} may be equal to two, if the SCS is 480 kHz the value of N_{gap} may be equal to eight, and if the SCS is 960 kHz the value of N_{gap} may be equal to 16.

Additionally, the random access occasion (e.g., the PRACH occasion) in the slot 405-c may be considered valid if a channelAccessMode parameter is set to semi-static (e.g., channelAccessMode=“semi-static”) and is provided. Further, the random access occasion in the slot 405-c may be considered valid based on the random access occasion not overlapping with a set of consecutive symbols before the start of a next channel occupancy time where the UE 115 may refrain from transmitting a random access occasion. Moreover, a candidate SSB/PBCH block index of the SSB/PBCH may correspond to a SSB/PBCH block index provided by a parameter in a SIB or a common configuration (e.g., ssb-PositionsInBurst in SIB1 or in Serving ('ellConfigCommon).

In some examples, the UE 115 may be provided with the time domain common configuration parameter (e.g., tdd-UL-DL-ConfigurationCommon) and the random access occasion within the slot 405 may be considered a valid random access occasion if the random access occasion is within a set of uplink symbols. As such, if the random access occasion is within the slot 405-a or the first sub-band 410 of the slot 405-c the random access occasion may be considered valid. Further, the random access occasion may be considered valid if the random access occasion does not precede a SSB/PBCH block in the slot 405 of the random access occasion (e.g., PRACH slot) and the slot 405 starts at least N_{gap} symbols after the most recent downlink symbol and at least N_{gap} symbols after the most recent SSB/PBCH block symbol. Additionally, or alternatively, the random access occasion may be considered valid if a channelAccessMode parameter is set to semi-static (e.g., channelAccessMode=“semi-static”) and is provided. Further, the random access occasion in the slot 405-c may be considered valid based on the random access occasion not overlapping with a set of consecutive symbols before the start of a next channel occupancy time where there may be an absence of any transmissions scheduled. Moreover, a candidate SSB/PBCH block index of the SSB/PBCH may correspond to an SSB/PBCH block index provided by a parameter in a SIB or a common configuration (e.g., ssb-PositionsInBurst in SIB1 or in ServingCellConfigCommon). In some cases, using such validity rules the UE 115 may determine that the random access occasion may be valid, and the UE 115 may transmit the random access preamble. In some examples, the type of random access preamble to be transmitted by the UE 115 may determine the value of Ngap. For example, for a preamble format B4, the value of N_{gap} may be equal to zero.

However, while the validity rules described herein consider the positioning of the random access occasion and a communication direction (e.g., uplink or downlink) of the slot 405 that the random access occasion may be within, the validity rules may refrain from considering the sub-band structure of a full-duplex slot (e.g., the slot 405-c). As such, in some examples, according to the techniques described herein, the UE 115 may use the validity rules described herein in addition to considering the sub-band structure of full-duplex slots. For example, the UE 115 may determine whether random access occasion is within an uplink sub-band of the slot 405-c (e.g., the first sub-band 410) or within a downlink sub-band of the slot 405-c (e.g., the second sub-band 415). In cases where the random access occasion falls within the first sub-band 410 of the slot 405-c, the random access occasion may be considered a valid random access occasion. However, if the random access occasion falls within the second sub-band 415 of the slot 405-c, the random access occasion may be considered an invalid random access occasion.

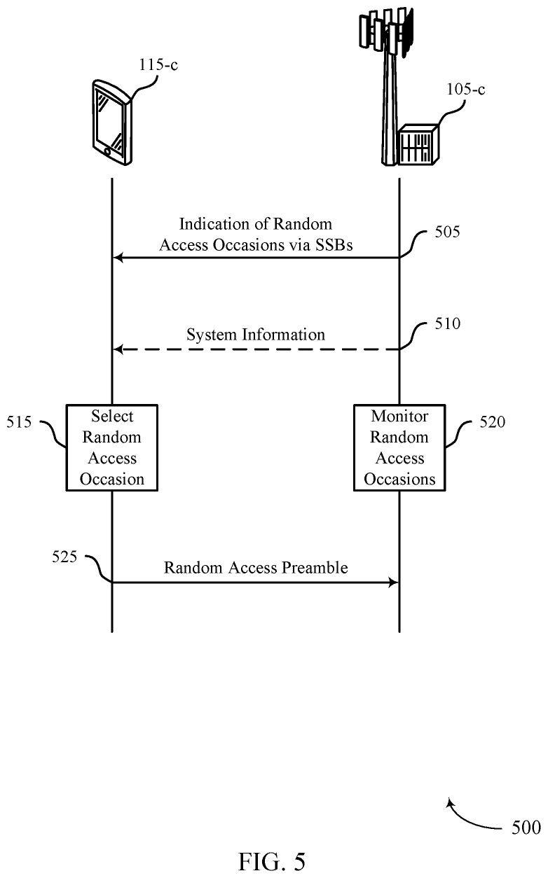

As described with reference to FIGS. 1-3, to prevent an increase in latency due to a UE 115 being allocated invalid random access occasions, the network entity 105 may indicate a set of random access occasions for full-duplex devices. For example, the network entity 105 may transmit a SIB indicating a set of random access occasions within the uplink sub-band of the slot 405-c (e.g., the first sub-band 410). In some examples, the UE 115 may be allocated a first set of random access occasions for half-duplex capable wireless device, and the SIB may indicate a second set of random access occasions for full-duplex capable wireless devices. In some implementations, the second set of random access occasions may all be allocated within the uplink sub-band of the slot 405-c (e.g., the first sub-band 410) such that the entire second set of random access occasions may be considered valid random access occasions within the slot 405-c (e.g., the full-duplex slot). Thus, a full-duplex capable UE 115 may transmit a random access preamble within a random access occasion from the second set of random access occasions. Additional descriptions of the UE 115 transmitting the random access preamble within a random access occasion from a set of random access indications indicated by the network entity 105 may be describe elsewhere herein, including with reference to FIG. 5.

FIG. 5 shows an example of a process flow 500 that supports random access occasions for full-duplex capable wireless devices in accordance with one or more aspects of the present disclosure. In some examples, the process flow 500 may implement or be implemented by the wireless communications system 100 or the wireless communications system 200. For example, the process flow 500 may include a UE 115-c and a network entity 105-c, which may be examples of devices described herein with reference to FIG. 1.

In the following description of the process flow 500, the operations between the UE 115-c and the network entity 105-c may be performed in different orders or at different times. Some operations may also be left out of the process flow 500, or other operations may be added. Although the UE 115-c and the network entity 105-c are shown performing the operations of the process flow 500, some aspects of some operations may also be performed by one or more other wireless devices.

At 505, the network entity 105-c may transmit a set of SSBs that may be indicative of both a first set of random access occasions and a second set of random access occasions different from the first set of random access occasions. The second set of random access occasions may be associated with full-duplex capable wireless devices (e.g., the UE 115-c). In some cases, the second set of random access occasions may be allocated for or dedicated for the full-duplex wireless devices. In some examples, the network entity 105-b may indicate that the second set of random access occasions may be offset from the first set of random access occasions by a time offset, a frequency offset or both. Further, there may be a first mapping between the set of SSBs and the first set of random access occasions and a second mapping between the set of SSBs and the second set of random access occasions.

Additionally, or alternatively, at 510, the network entity 105-c may transmit system information (e.g., via a SIB) that indicates the second set of random access occasions associated with, allocated for, or dedicated for the full-duplex capable wireless devices. The system information may be transmitted based on transmitting the set of SSBs at 505. In some examples, the network entity 105-c may transmit the system information to indicate a random access occasion for the full-duplex capable wireless devices to use for transmission of the random access preamble. As such, the random access preamble may be received, from the UE 115-c, at 525 via the random access occasion indicated by the system information. In some cases, the network entity 105-c may transmit the system information to also indicate the time offset, the frequency offset, or both, that the second set of random access occasions is offset from the first set of random access occasions.

At 515, the UE 115-c may select a random access occasion from the first set of random access occasion or from the second set of random access occasions. In some cases, the selection may be based on the capability of the UE 115-c. For example, a full-duplex capable UE 115 (e.g., the UE 115-c) may be capable of selecting a random access occasion from the first set of random access occasions or from the second set of random access occasions. However, a half-duplex UE 115 may only be capable of selecting a random access occasion from the first set of random access occasions. As such, at 520, the network entity 105-c may monitor both the first set of random access occasions and the second set of random access occasions.

At 525, the UE 115-c may transmit, to the network entity 105-c during a random access occasion (e.g., the selected random access occasion), a random access preamble based on the UE 115-c being a full-duplex capable wireless device. The network entity 105-c may receive, from the UE 115-c, the random access occasion based on monitoring both the first set of random access occasions and the second set of random access occasions at 520. In some examples, the UE 115-c may transmit, to the network entity 105-c, the random access preamble during the random access occasion which may be a random access occasion of the first set of random access occasions or of the second set of random access occasions. The UE 115-c may select to transmit the random access preamble via a random access occasion of the first set of random access occasions or of the second set of random access occasions based on the capability of the UE 115-c.

In some examples, the UE 115-c may transmit, to the network entity 105-c, the random access preamble during the random access occasion where the random access preamble may be from a first set of random access preambles associated with, allocated for, or dedicated for full-duplex capable wireless devices. In some cases, the first set of random access preambles may be the same or different from a second set of random access preambles associated with, allocated for, or dedicated for half-duplex capable wireless devices. Further, the UE 115-c may transmit, to the network entity 105-c, the random access preamble via one or more symbols of a slot within the random access occasion of the second set of random access occasions and in accordance with a set of validity rules. In some cases, the set of validity rules may indicate that the slot is valid based on a quantity of symbols after the transmission of a SSB from the set of SSBs and a communication direction of the slot (e.g., uplink or downlink communication direction). In some other cases, the set of validity rules may indicate that the slot is valid based on the quantity of symbols after the transmission of a SSB from the set of SSBs, the communication direction of the slot, and whether the slot of the random access occasion may be within an uplink sub-band or a downlink sub-band of the slot.

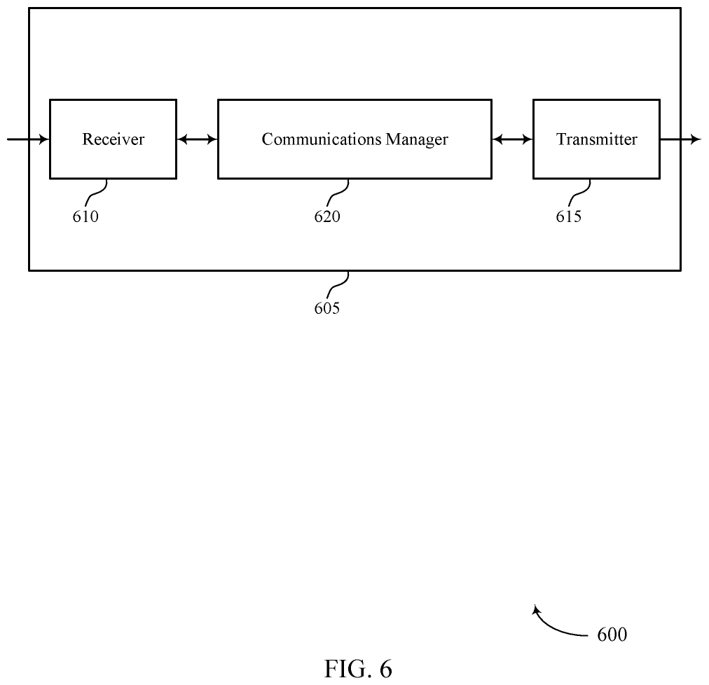

FIG. 6 shows a block diagram 600 of a device 605 that supports random access occasions for full-duplex capable wireless devices in accordance with one or more aspects of the present disclosure. The device 605 may be an example of aspects of a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of random access occasions for full-duplex capable wireless devices as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting a set of SSBs that indicate both a first set of random access occasions and a second set of random access occasions different from the first set of random access occasions, the second set of random access occasions associated with full-duplex capable wireless devices. The communications manager 620 is capable of, configured to, or operable to support a means for monitoring both the first set of random access occasions and the second set of random access occasions. The communications manager 620 is capable of, configured to, or operable to support a means for receiving, from a UE during a random access occasion, a random access preamble based on the UE being a full-duplex capable wireless device and based on the monitoring of the first set of random access occasions and the second set of random access occasions.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for a network entity to indicate a set of random access occasions associated with, allocated for, or dedicated for full-duplex wireless devices (e.g., UEs 115) for reduced processing, reduced power consumption, and a more efficient utilization of communication resources.

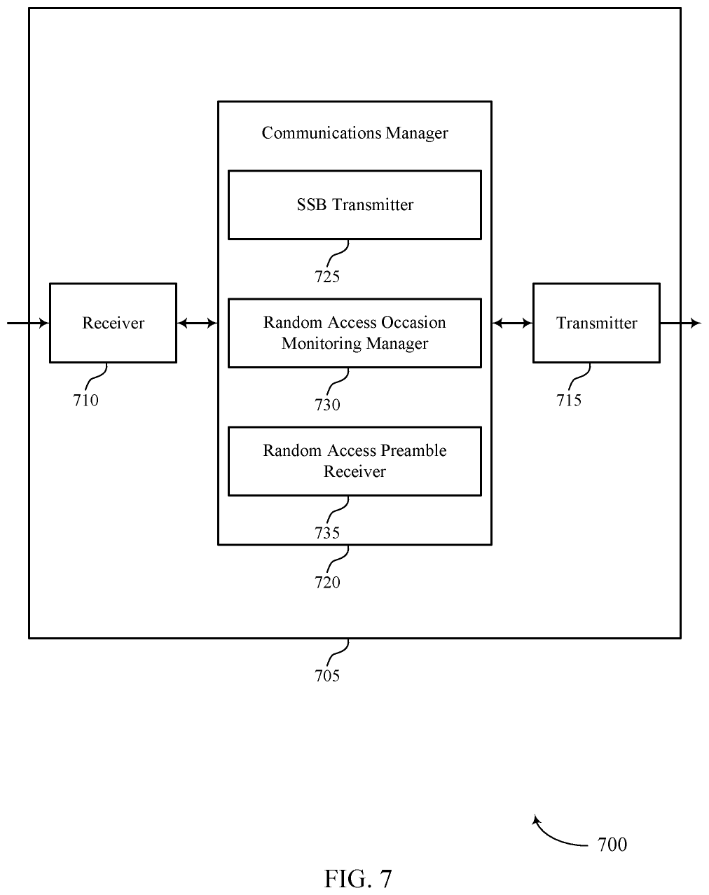

FIG. 7 shows a block diagram 700 of a device 705 that supports random access occasions for full-duplex capable wireless devices in accordance with one or more aspects of the present disclosure. The device 705 may be an example of aspects of a device 605 or a network entity 105 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of random access occasions for full-duplex capable wireless devices as described herein. For example, the communications manager 720 may include an SSB transmitter 725, a random access occasion monitoring manager 730, a random access preamble receiver 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The SSB transmitter 725 is capable of, configured to, or operable to support a means for transmitting a set of SSBs that indicate both a first set of random access occasions and a second set of random access occasions different from the first set of random access occasions, the second set of random access occasions associated with full-duplex capable wireless devices. The random access occasion monitoring manager 730 is capable of, configured to, or operable to support a means for monitoring both the first set of random access occasions and the second set of random access occasions. The random access preamble receiver 735 is capable of, configured to, or operable to support a means for receiving, from a UE during a random access occasion, a random access preamble based on the UE being a full-duplex capable wireless device and based on the monitoring of the first set of random access occasions and the second set of random access occasions.

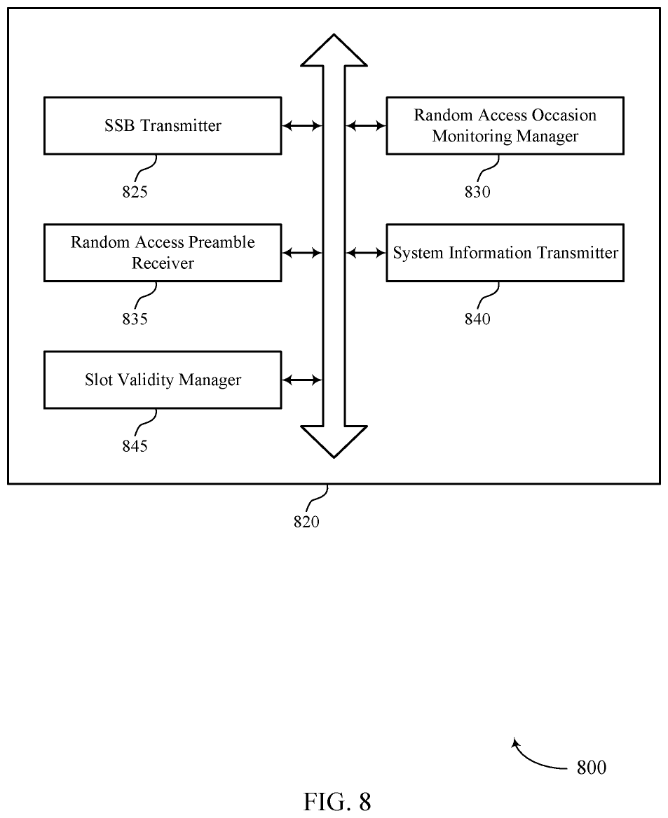

FIG. 8 shows a block diagram 800 of a communications manager 820 that supports random access occasions for full-duplex capable wireless devices in accordance with one or more aspects of the present disclosure. The communications manager 820 may be an example of aspects of a communications manager 620, a communications manager 720, or both, as described herein. The communications manager 820, or various components thereof, may be an example of means for performing various aspects of random access occasions for full-duplex capable wireless devices as described herein. For example, the communications manager 820 may include an SSB transmitter 825, a random access occasion monitoring manager 830, a random access preamble receiver 835, a system information transmitter 840, a slot validity manager 845, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The SSB transmitter 825 is capable of, configured to, or operable to support a means for transmitting a set of SSBs that indicate both a first set of random access occasions and a second set of random access occasions different from the first set of random access occasions, the second set of random access occasions associated with full-duplex capable wireless devices. The random access occasion monitoring manager 830 is capable of, configured to, or operable to support a means for monitoring both the first set of random access occasions and the second set of random access occasions. The random access preamble receiver 835 is capable of, configured to, or operable to support a means for receiving, from a UE during a random access occasion, a random access preamble based on the UE being a full-duplex capable wireless device and based on the monitoring of the first set of random access occasions and the second set of random access occasions.

In some examples, to support transmitting the set of SSBs, the SSB transmitter 825 is capable of, configured to, or operable to support a means for transmitting system information that indicates the second set of random access occasions associated with the full-duplex capable wireless devices, the system information being transmitted as part of the set of SSBs.

In some examples, the system information transmitter 840 is capable of, configured to, or operable to support a means for transmitting system information that indicates the random access occasion for the full-duplex capable wireless devices to use for transmission of random access preamble transmission, where the random access preamble is received from the UE via the random access occasion indicated by the system information.

In some examples, to support receiving the random access preamble, the random access preamble receiver 835 is capable of, configured to, or operable to support a means for receiving, from the UE, the random access preamble during the random access occasion, where the random access occasion is of the first set of random access occasions or of the second set of random access occasions.

In some examples, to support transmitting the set of SSBs, the SSB transmitter 825 is capable of, configured to, or operable to support a means for transmitting the set of SSBs that indicate the first set of random access occasions and the second set of random access occasions, where the second set of random access occasions are offset from the first set of random access occasions in accordance with a time offset, a frequency offset, or both.

In some examples, the system information transmitter 840 is capable of, configured to, or operable to support a means for transmitting system information that indicates the time offset, the frequency offset, or both.

In some examples, to support receiving the random access preamble, the random access preamble receiver 835 is capable of, configured to, or operable to support a means for receiving, during the random access occasion of the second set of random access occasions, the random access preamble from a first set of random access preambles associated with the full-duplex capable wireless devices, where the first set of random access preambles is the same or different from a second set of random access preambles associated with half-duplex wireless devices.

In some examples, the slot validity manager 845 is capable of, configured to, or operable to support a means for receiving, from the UE, the random access preamble via one or more symbols of a slot within the random access occasion of the second set of random access occasions and in accordance with a set of validity rules, where the set of validity rules indicate that the slot is valid based on a quantity of symbols after transmission of a SSB of the set of SSBs and a communication direction associated with the slot.

In some examples, the slot validity manager 845 is capable of, configured to, or operable to support a means for receiving, from the UE, the random access preamble via one or more symbols of a slot within the random access occasion of the second set of random access occasions and in accordance with a set of validity rules, where the set of validity rules indicate that the slot is valid based on a quantity of symbols after transmission of a SSB of the set of SSBs, a communication direction associated with the slot, and whether the slot of the random access occasion is within an uplink sub-band on a full-duplex slot.

In some examples, the first set of random access occasions is indicated by the set of SSBs and a first mapping between the set of SSBs and the first set of random access occasions, and where the second set of random access occasions is indicated by the set of SSBs and a second mapping between the set of SSBs and the second set of random access occasions.

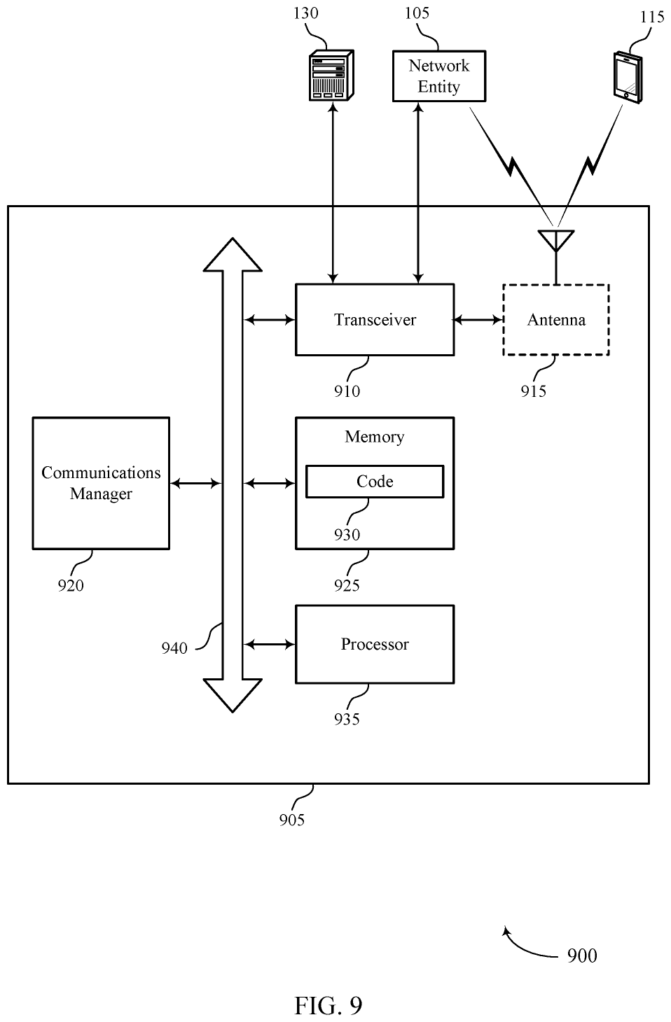

FIG. 9 shows a diagram of a system 900 including a device 905 that supports random access occasions for full-duplex capable wireless devices in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., a communication link 125, a backhaul communication link 120, a midhaul communication link 162, a fronthaul communication link 168).

The at least one memory 925 may include RAM, ROM, or any combination thereof. The at least one memory 925 may store computer-readable, computer-executable code 930 including instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may contain, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting random access occasions for full-duplex capable wireless devices). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925). In some implementations, the at least one processor 935 may be a component of a processing system. A processing system may generally refer to a system or series of machines or components that receives inputs and processes the inputs to produce a set of outputs (which may be passed to other systems or components of, for example, the device 905). For example, a processing system of the device 905 may refer to a system including the various other components or subcomponents of the device 905, such as the at least one processor 935, or the transceiver 910, or the communications manager 920, or other components or combinations of components of the device 905. The processing system of the device 905 may interface with other components of the device 905, and may process information received from other components (such as inputs or signals) or output information to other components. For example, a chip or modem of the device 905 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 905 may transmit information output from the chip or modem. Additionally, or alternatively, in some implementations, the one or more interfaces may refer to an interface between the processing system of the chip or modem and a receiver, such that the device 905 may obtain information or signal inputs, and the information may be passed to the processing system. A person having ordinary skill in the art will readily recognize that a first interface also may obtain information or signal inputs, and a second interface also may output information or signal outputs.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communications in accordance with examples as disclosed herein. For example, the communications manager 920 is capable of, configured to, or operable to support a means for transmitting a set of SSBs that indicate both a first set of random access occasions and a second set of random access occasions different from the first set of random access occasions, the second set of random access occasions associated with full-duplex capable wireless devices. The communications manager 920 is capable of, configured to, or operable to support a means for monitoring both the first set of random access occasions and the second set of random access occasions. The communications manager 920 is capable of, configured to, or operable to support a means for receiving, from a UE during a random access occasion, a random access preamble based on the UE being a full-duplex capable wireless device and based on the monitoring of the first set of random access occasions and the second set of random access occasions.

By including or configuring the communications manager 920 in accordance with examples as described herein, the device 905 may support techniques for a UE 115 to use a random access occasion from a set of random access occasions associated with, allocated for, or dedicated for full-duplex wireless devices (e.g., UEs 115) for improved communication reliability, reduced power consumption, more efficient utilization of communication resources, and improved coordination between devices.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of random access occasions for full-duplex capable wireless devices as described herein, or the at least one processor 935 and the at least one memory 925 may be otherwise configured to, individually or collectively, perform or support such operations.

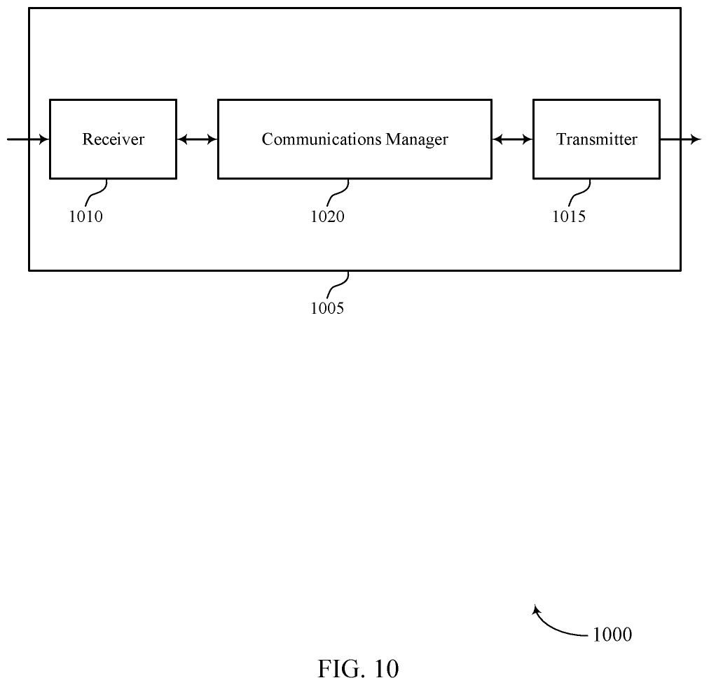

FIG. 10 shows a block diagram 1000 of a device 1005 that supports random access occasions for full-duplex capable wireless devices in accordance with one or more aspects of the present disclosure. The device 1005 may be an example of aspects of a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to random access occasions for full-duplex capable wireless devices). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to random access occasions for full-duplex capable wireless devices). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of random access occasions for full-duplex capable wireless devices as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for receiving one or more SSBs that indicate both a first set of random access occasions and a second set of random access occasions different from the first set of random access occasions, the second set of random access occasions associated with full-duplex capable wireless devices. The communications manager 1020 is capable of, configured to, or operable to support a means for transmitting, to a network entity, during a random access occasion, a random access preamble based on the UE being a full-duplex capable wireless device and based on receiving the one or more SSBs indicating the first set of random access occasions and the second set of random access occasions.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for a network entity to indicate a set of random access occasions associated with, allocated for, or dedicated for full-duplex wireless devices (e.g., UEs 115) for reduced processing, reduced power consumption, and a more efficient utilization of communication resources.

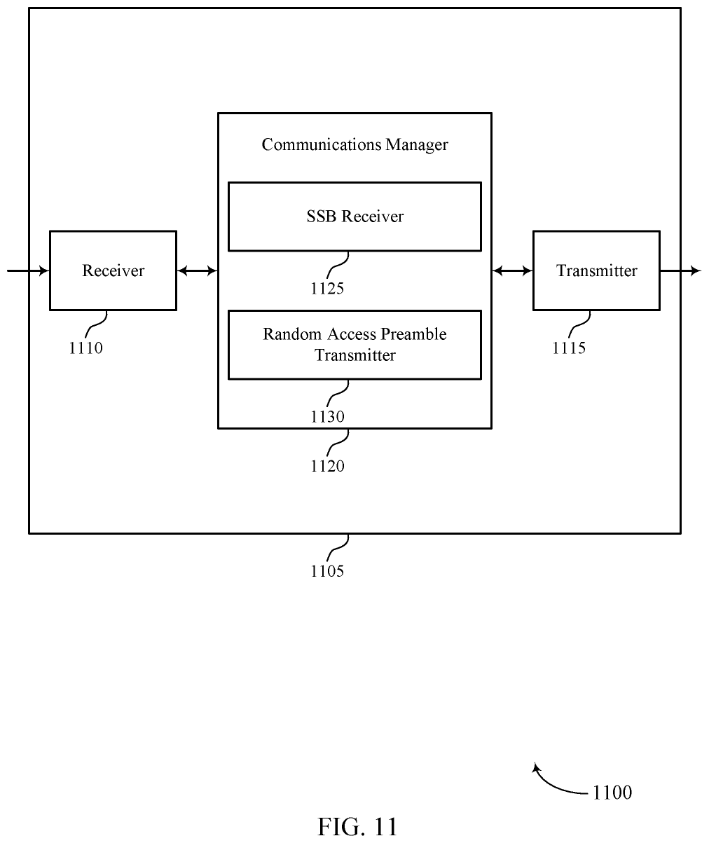

FIG. 11 shows a block diagram 1100 of a device 1105 that supports random access occasions for full-duplex capable wireless devices in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to random access occasions for full-duplex capable wireless devices). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to random access occasions for full-duplex capable wireless devices). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of random access occasions for full-duplex capable wireless devices as described herein. For example, the communications manager 1120 may include an SSB receiver 1125 a random access preamble transmitter 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The SSB receiver 1125 is capable of, configured to, or operable to support a means for receiving one or more SSBs that indicate both a first set of random access occasions and a second set of random access occasions different from the first set of random access occasions, the second set of random access occasions associated with full-duplex capable wireless devices. The random access preamble transmitter 1130 is capable of, configured to, or operable to support a means for transmitting, to a network entity, during a random access occasion, a random access preamble based on the UE being a full-duplex capable wireless device and based on receiving the one or more SSBs indicating the first set of random access occasions and the second set of random access occasions.

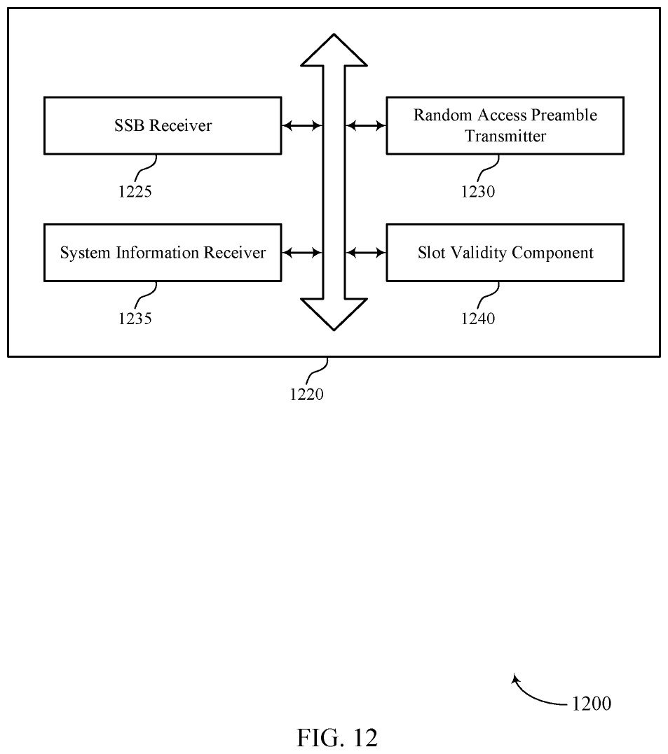

FIG. 12 shows a block diagram 1200 of a communications manager 1220 that supports random access occasions for full-duplex capable wireless devices in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of random access occasions for full-duplex capable wireless devices as described herein. For example, the communications manager 1220 may include an SSB receiver 1225, a random access preamble transmitter 1230, a system information receiver 1235, a slot validity component 1240, or any combination thereof. Each of these components, or components or subcomponents thereof (e.g., one or more processors, one or more memories), may communicate, directly or indirectly, with one another (e.g., via one or more buses).

The communications manager 1220 may support wireless communications in accordance with examples as disclosed herein. The SSB receiver 1225 is capable of, configured to, or operable to support a means for receiving one or more SSBs that indicate both a first set of random access occasions and a second set of random access occasions different from the first set of random access occasions, the second set of random access occasions associated with full-duplex capable wireless devices. The random access preamble transmitter 1230 is capable of, configured to, or operable to support a means for transmitting, to a network entity, during a random access occasion, a random access preamble based on the UE being a full-duplex capable wireless device and based on receiving the one or more SSBs indicating the first set of random access occasions and the second set of random access occasions.

In some examples, to support receiving the one or more SSBs, the SSB receiver 1225 is capable of, configured to, or operable to support a means for receiving, from the network entity, system information that indicates the second set of random access occasions associated with the full-duplex capable wireless devices, the system information being received based on receiving of the one or more SSBs.

In some examples, the system information receiver 1235 is capable of, configured to, or operable to support a means for receiving, from the network entity, system information that indicates the random access occasion of for the UE to use for transmission, where the random access preamble is transmitted to the network entity via the random access occasion indicated by the system information.

In some examples, to support transmitting the random access preamble, the random access preamble transmitter 1230 is capable of, configured to, or operable to support a means for transmitting the random access preamble during the random access occasion, where the random access occasion is of the first set of random access occasions or of the second set of random access occasions.

In some examples, to support receiving the one or more SSBs, the system information receiver 1235 is capable of, configured to, or operable to support a means for receiving the one or more SSBs that indicate the first set of random access occasions and the second set of random access occasions, where the second set of random access occasions are offset from the first set of random access occasions in accordance with a time offset, a frequency offset, or both.

In some examples, the second set of random access occasions are offset from the first set of random access occasions, and the system information receiver 1235 is capable of, configured to, or operable to support a means for receiving, from the network entity, system information that indicates the time offset, the frequency offset, or both.

In some examples, to support transmitting the random access preamble, the random access preamble transmitter 1230 is capable of, configured to, or operable to support a means for transmitting, during the random access occasion of the second set of random access occasions, the random access preamble from a first set of random access preambles associated with the full-duplex capable wireless devices, where the first set of random access preambles is the same or different from a second set of random access preambles associated with half-duplex wireless devices.

In some examples, the slot validity component 1240 is capable of, configured to, or operable to support a means for transmitting, to the network entity, the random access preamble via one or more symbols of a slot within the random access occasion the second set of random access occasions and in accordance with a set of validity rules, where the set of validity rules indicate that the slot is valid based on a quantity of symbols after reception of a SSB of the one or more SSBs and a communication direction associated with the slot.

In some examples, the slot validity component 1240 is capable of, configured to, or operable to support a means for transmitting, to the network entity, the random access preamble via one or more symbols of a slot within the random access occasion of the second set of random access occasions and in accordance with a set of validity rules, where the set of validity rules indicate that the slot is valid based on a quantity of symbols after reception of a SSB of the one or more SSBs, a communication direction associated with the slot, and whether the slot of the random access occasion is within an uplink sub-band of a full-duplex slot.

In some examples, the first set of random access occasions is indicated by the one or more SSBs and a first mapping between the one or more SSBs and the first set of random access occasions, and where the second set of random access occasions is indicated by the one or more SSBs and a second mapping between the one or more SSBs and the second set of random access occasions.

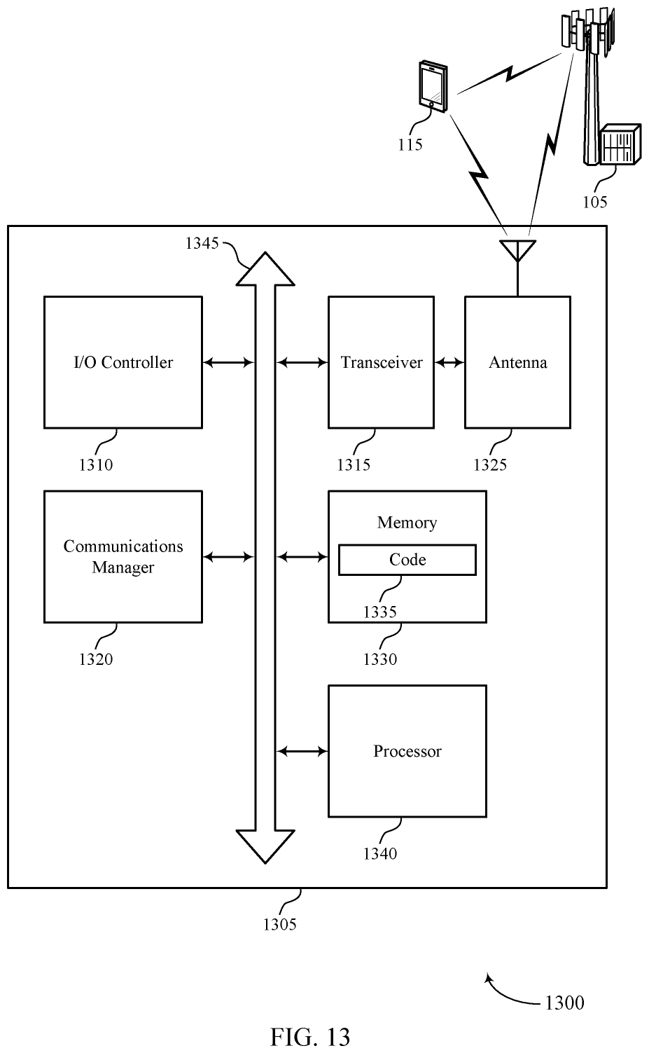

FIG. 13 shows a diagram of a system 1300 including a device 1305 that supports random access occasions for full-duplex capable wireless devices in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include random access memory (RAM) and read-only memory (ROM). The at least one memory 1330 may store computer-readable, computer-executable code 1335 including instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may contain, among other things, a basic I/O system (BIOS) which may control basic hardware or software operation such as the interaction with peripheral components or devices.

The at least one processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting random access occasions for full-duplex capable wireless devices). For example, the device 1305 or a component of the device 1305 may include at least one processor 1340 and at least one memory 1330 coupled with or to the at least one processor 1340, the at least one processor 1340 and at least one memory 1330 configured to perform various functions described herein. In some examples, the at least one processor 1340 may include multiple processors and the at least one memory 1330 may include multiple memories. One or more of the multiple processors may be coupled with one or more of the multiple memories, which may, individually or collectively, be configured to perform various functions herein.

The communications manager 1320 may support wireless communications in accordance with examples as disclosed herein. For example, the communications manager 1320 is capable of, configured to, or operable to support a means for receiving one or more SSBs that indicate both a first set of random access occasions and a second set of random access occasions different from the first set of random access occasions, the second set of random access occasions associated with full-duplex capable wireless devices. The communications manager 1320 is capable of, configured to, or operable to support a means for transmitting, to a network entity, during a random access occasion, a random access preamble based on the UE being a full-duplex capable wireless device and based on receiving the one or more SSBs indicating the first set of random access occasions and the second set of random access occasions.

By including or configuring the communications manager 1320 in accordance with examples as described herein, the device 1305 may support techniques for a UE 115 to use a random access occasion from a set of random access occasions associated with, allocated for, or dedicated for full-duplex wireless devices (e.g., UEs 115) for improved communication reliability, reduced power consumption, more efficient utilization of communication resources, and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of random access occasions for full-duplex capable wireless devices as described herein, or the at least one processor 1340 and the at least one memory 1330 may be otherwise configured to, individually or collectively, perform or support such operations.

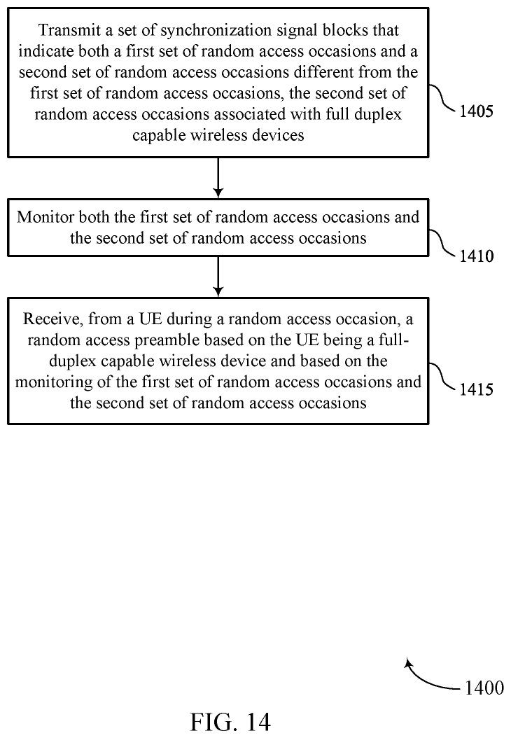

FIG. 14 shows a flowchart illustrating a method 1400 that supports random access occasions for full-duplex capable wireless devices in accordance with aspects of the present disclosure. The operations of the method 1400 may be implemented by a network entity or its components as described herein. For example, the operations of the method 1400 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a set of SSBs that indicate both a first set of random access occasions and a second set of random access occasions different from the first set of random access occasions, the second set of random access occasions associated with full-duplex capable wireless devices. The operations of block 1405 may be performed in accordance with examples as disclosed herein. In some examples, aspects of the operations of 1405 may be performed by an SSB transmitter 825 as described with reference to FIG. 8.

At 1410, the method may include monitoring both the first set of random access occasions and the second set of random access occasions. The operations of block 1410 may be performed in accordance with examples as disclosed herein. In some examples, aspects of the operations of 1410 may be performed by a random access occasion monitoring manager 830 as described with reference to FIG. 8.

At 1415, the method may include receiving, from a UE during a random access occasion, a random access preamble based on the UE being a full-duplex capable wireless device and based on the monitoring of the first set of random access occasions and the second set of random access occasions. The operations of block 1415 may be performed in accordance with examples as disclosed herein. In some examples, aspects of the operations of 1415 may be performed by a random access preamble receiver 835 as described with reference to FIG. 8.

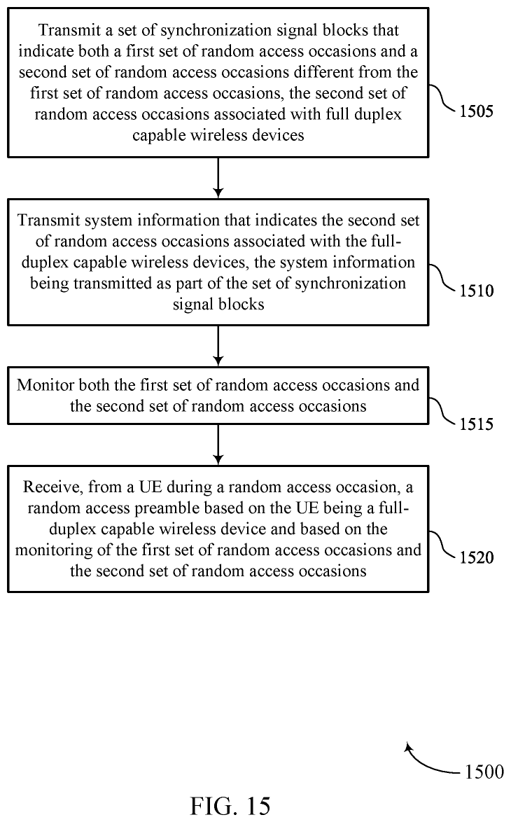

FIG. 15 shows a flowchart illustrating a method 1500 that supports random access occasions for full-duplex capable wireless devices in accordance with aspects of the present disclosure. The operations of the method 1500 may be implemented by a network entity or its components as described herein. For example, the operations of the method 1500 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a set of SSBs that indicate both a first set of random access occasions and a second set of random access occasions different from the first set of random access occasions, the second set of random access occasions associated with full-duplex capable wireless devices. The operations of block 1505 may be performed in accordance with examples as disclosed herein. In some examples, aspects of the operations of 1505 may be performed by an SSB transmitter 825 as described with reference to FIG. 8.

At 1510, the method may include transmitting system information that indicates the second set of random access occasions associated with the full-duplex capable wireless devices, the system information being transmitted as part of the set of SSBs. The operations of block 1510 may be performed in accordance with examples as disclosed herein. In some examples, aspects of the operations of 1510 may be performed by an SSB transmitter 825 as described with reference to FIG. 8.

At 1515, the method may include monitoring both the first set of random access occasions and the second set of random access occasions. The operations of block 1515 may be performed in accordance with examples as disclosed herein. In some examples, aspects of the operations of 1515 may be performed by a random access occasion monitoring manager 830 as described with reference to FIG. 8.

At 1520, the method may include receiving, from a UE during a random access occasion, a random access preamble based on the UE being a full-duplex capable wireless device and based on the monitoring of the first set of random access occasions and the second set of random access occasions. The operations of block 1520 may be performed in accordance with examples as disclosed herein. In some examples, aspects of the operations of 1520 may be performed by a random access preamble receiver 835 as described with reference to FIG. 8.

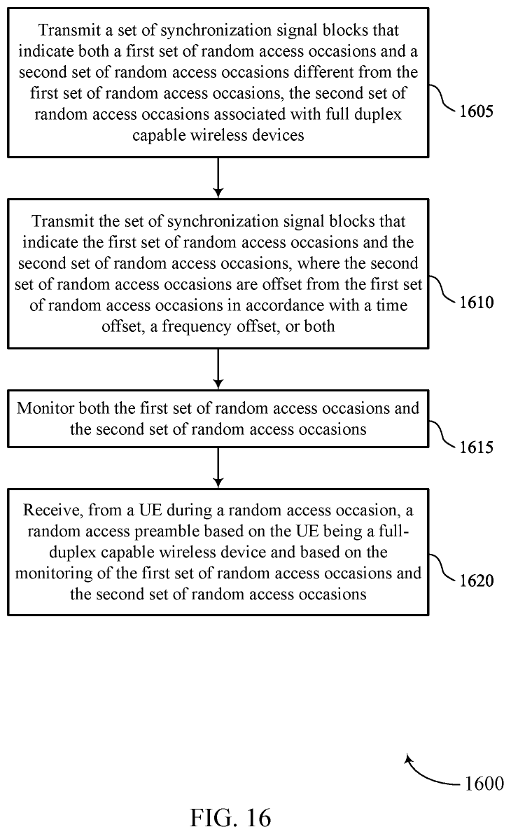

FIG. 16 shows a flowchart illustrating a method 1600 that supports random access occasions for full-duplex capable wireless devices in accordance with aspects of the present disclosure. The operations of the method 1600 may be implemented by a network entity or its components as described herein. For example, the operations of the method 1600 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a set of SSBs that indicate both a first set of random access occasions and a second set of random access occasions different from the first set of random access occasions, the second set of random access occasions associated with full-duplex capable wireless devices. The operations of block 1605 may be performed in accordance with examples as disclosed herein. In some examples, aspects of the operations of 1605 may be performed by an SSB transmitter 825 as described with reference to FIG. 8.

At 1610, the method may include transmitting the set of SSBs that indicate the first set of random access occasions and the second set of random access occasions, where the second set of random access occasions are offset from the first set of random access occasions in accordance with a time offset, a frequency offset, or both. The operations of block 1610 may be performed in accordance with examples as disclosed herein. In some examples, aspects of the operations of 1610 may be performed by an SSB transmitter 825 as described with reference to FIG. 8.

At 1615, the method may include monitoring both the first set of random access occasions and the second set of random access occasions. The operations of block 1615 may be performed in accordance with examples as disclosed herein. In some examples, aspects of the operations of 1615 may be performed by a random access occasion monitoring manager 830 as described with reference to FIG. 8.

At 1620, the method may include receiving, from a UE during a random access occasion, a random access preamble based on the UE being a full-duplex capable wireless device and based on the monitoring of the first set of random access occasions and the second set of random access occasions. The operations of block 1620 may be performed in accordance with examples as disclosed herein. In some examples, aspects of the operations of 1620 may be performed by a random access preamble receiver 835 as described with reference to FIG. 8.

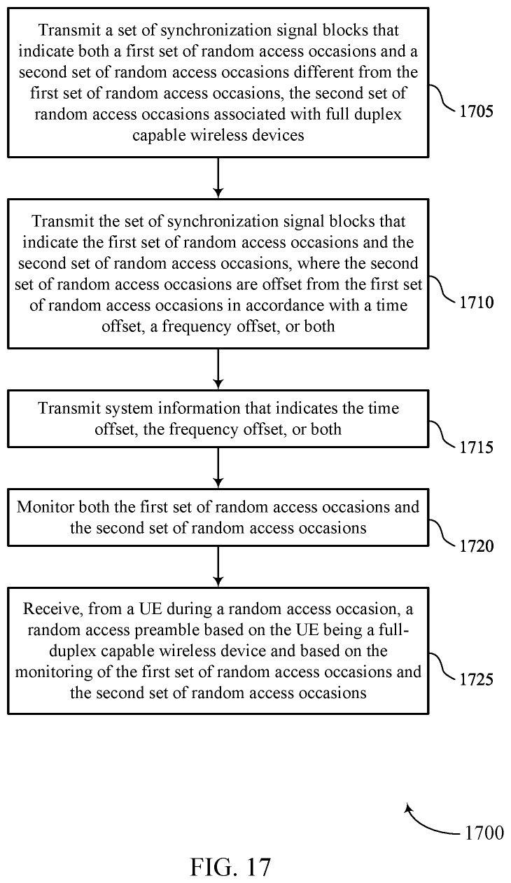

FIG. 17 shows a flowchart illustrating a method 1700 that supports random access occasions for full-duplex capable wireless devices in accordance with aspects of the present disclosure. The operations of the method 1700 may be implemented by a network entity or its components as described herein. For example, the operations of the method 1700 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a set of SSBs that indicate both a first set of random access occasions and a second set of random access occasions different from the first set of random access occasions, the second set of random access occasions associated with full-duplex capable wireless devices. The operations of block 1705 may be performed in accordance with examples as disclosed herein. In some examples, aspects of the operations of 1705 may be performed by an SSB transmitter 825 as described with reference to FIG. 8.

At 1710, the method may include transmitting the set of SSBs that indicate the first set of random access occasions and the second set of random access occasions, where the second set of random access occasions are offset from the first set of random access occasions in accordance with a time offset, a frequency offset, or both. The operations of block 1710 may be performed in accordance with examples as disclosed herein. In some examples, aspects of the operations of 1710 may be performed by an SSB transmitter 825 as described with reference to FIG. 8.

At 1715, the method may include transmitting system information that indicates the time offset, the frequency offset, or both. The operations of block 1715 may be performed in accordance with examples as disclosed herein. In some examples, aspects of the operations of 1715 may be performed by a system information transmitter 840 as described with reference to FIG. 8.

At 1720, the method may include monitoring both the first set of random access occasions and the second set of random access occasions. The operations of block 1720 may be performed in accordance with examples as disclosed herein. In some examples, aspects of the operations of 1720 may be performed by a random access occasion monitoring manager 830 as described with reference to FIG. 8.

At 1725, the method may include receiving, from a UE during a random access occasion, a random access preamble based on the UE being a full-duplex capable wireless device and based on the monitoring of the first set of random access occasions and the second set of random access occasions. The operations of block 1725 may be performed in accordance with examples as disclosed herein. In some examples, aspects of the operations of 1725 may be performed by a random access preamble receiver 835 as described with reference to FIG. 8.

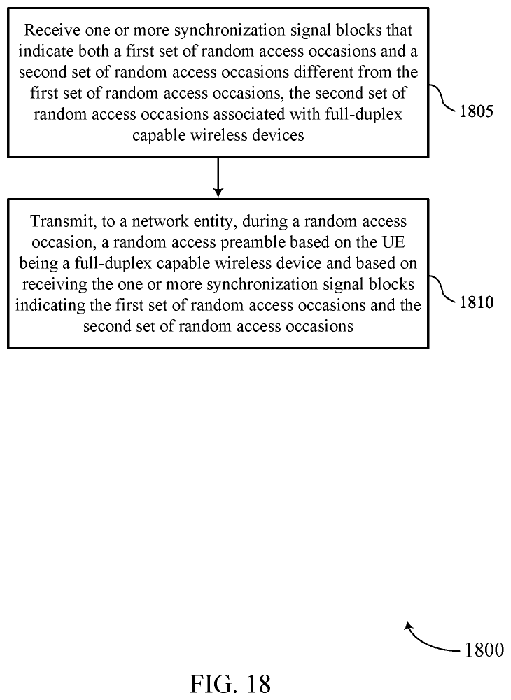

FIG. 18 shows a flowchart illustrating a method 1800 that supports random access occasions for full-duplex capable wireless devices in accordance with aspects of the present disclosure. The operations of the method 1800 may be implemented by a UE or its components as described herein. For example, the operations of the method 1800 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1805, the method may include receiving one or more SSBs that indicate both a first set of random access occasions and a second set of random access occasions different from the first set of random access occasions, the second set of random access occasions associated with full-duplex capable wireless devices. The operations of block 1805 may be performed in accordance with examples as disclosed herein. In some examples, aspects of the operations of 1805 may be performed by an SSB receiver 1225 as described with reference to FIG. 12.

At 1810, the method may include transmitting, to a network entity, during a random access occasion, a random access preamble based on the UE being a full-duplex capable wireless device and based on receiving the one or more SSBs indicating the first set of random access occasions and the second set of random access occasions. The operations of block 1810 may be performed in accordance with examples as disclosed herein. In some examples, aspects of the operations of 1810 may be performed by a random access preamble transmitter 1230 as described with reference to FIG. 12.

The following provides an overview of aspects of the present disclosure:

Aspect 1: A method for wireless communications by a network entity, comprising: transmitting a set of SSBs that indicate both a first set of random access occasions and a second set of random access occasions different from the first set of random access occasions, the second set of random access occasions associated with full duplex capable wireless devices; monitoring both the first set of random access occasions and the second set of random access occasions; and receiving, from a UE during a random access occasion, a random access preamble based at least in part on the UE being a full-duplex capable wireless device and based at least in part on the monitoring of the first set of random access occasions and the second set of random access occasions.

Aspect 2: The method of aspect 1, wherein transmitting the set of SSBs comprises: transmitting system information that indicates the second set of random access occasions associated with the full-duplex capable wireless devices, the system information being transmitted as part of the set of SSBs.

Aspect 3: The method of any of aspects 1 through 2, further comprising: transmitting system information that indicates the random access occasion for the full-duplex capable wireless devices to use for transmission of random access preamble transmission, wherein the random access preamble is received from the UE via the random access occasion indicated by the system information.

Aspect 4: The method of any of aspects 1 through 3, wherein receiving the random access preamble comprises: receiving, from the UE, the random access preamble during the random access occasion, wherein the random access occasion is of the first set of random access occasions or of the second set of random access occasions.

Aspect 5: The method of any of aspects 1 through 4, wherein transmitting the set of SSBs comprises: transmitting the set of SSBs that indicate the first set of random access occasions and the second set of random access occasions, wherein the second set of random access occasions are offset from the first set of random access occasions in accordance with a time offset, a frequency offset, or both.

Aspect 6: The method of aspect 5, further comprising transmitting system information that indicates the time offset, the frequency offset, or both.

Aspect 7: The method of any of aspects 1 through 6, wherein receiving the random access preamble comprises: receiving, during the random access occasion of the second set of random access occasions, the random access preamble from a first set of random access preambles associated with the full-duplex capable wireless devices, wherein the first set of random access preambles is the same or different from a second set of random access preambles associated with half-duplex wireless devices.

Aspect 8: The method of any of aspects 1 through 7, further comprising: receiving, from the UE, the random access preamble via one or more symbols of a slot within the random access occasion of the second set of random access occasions and in accordance with a set of validity rules, wherein the set of validity rules indicate that the slot is valid based at least in part on a quantity of symbols after transmission of a SSB of the set of SSBs and a communication direction associated with the slot.

Aspect 9: The method of any of aspects 1 through 8, further comprising: receiving, from the UE, the random access preamble via one or more symbols of a slot within the random access occasion of the second set of random access occasions and in accordance with a set of validity rules, wherein the set of validity rules indicate that the slot is valid based at least in part on a quantity of symbols after transmission of a SSB of the set of SSBs, a communication direction associated with the slot, and whether the slot of the random access occasion is within an uplink sub-band on a full-duplex slot.

Aspect 10: The method of any of aspects 1 through 9, wherein the first set of random access occasions is indicated by the set of SSBs and a first mapping between the set of SSBs and the first set of random access occasions, and wherein the second set of random access occasions is indicated by the set of SSBs and a second mapping between the set of SSBs and the second set of random access occasions.

Aspect 11: A method for wireless communications by a UE, comprising: receiving one or more SSBs that indicate both a first set of random access occasions and a second set of random access occasions different from the first set of random access occasions, the second set of random access occasions associated with full-duplex capable wireless devices; and transmitting, to a network entity, during a random access occasion, a random access preamble based at least in part on the UE being a full-duplex capable wireless device and based at least in part on receiving the one or more SSBs indicating the first set of random access occasions and the second set of random access occasions.

Aspect 12: The method of aspect 11, wherein receiving the one or more SSBs comprises: receiving, from the network entity, system information that indicates the second set of random access occasions associated with the full-duplex capable wireless devices, the system information being received based at least in part on receiving of the one or more SSBs.

Aspect 13: The method of any of aspects 11 through 12, further comprising: receiving, from the network entity, system information that indicates a random access occasion of for the UE to use for transmission, wherein the random access preamble is transmitted to the network entity via the random access occasion indicated by the system information.

Aspect 14: The method of any of aspects 11 through 13, wherein transmitting the random access preamble comprises: transmitting the random access preamble during the random access occasion, wherein the random access occasion is of the first set of random access occasions or of the second set of random access occasions.

Aspect 15: The method of any of aspects 11 through 14, wherein receiving the one or more SSBs comprises: receiving the one or more SSBs that indicate the first set of random access occasions and the second set of random access occasions, wherein the second set of random access occasions are offset from the first set of random access occasions in accordance with a time offset, a frequency offset, or both.

Aspect 16: The method of aspect 15, wherein the second set of random access occasions are offset from the first set of random access occasions, and the method further comprising: receiving, from the network entity, system information that indicates the time offset, the frequency offset, or both.

Aspect 17: The method of any of aspects 11 through 16, wherein transmitting the random access preamble comprises: transmitting, during the random access occasion of the second set of random access occasions, the random access preamble from a first set of random access preambles associated with the full-duplex capable wireless devices, wherein the first set of random access preambles is the same or different from a second set of random access preambles associated with half-duplex wireless devices.

Aspect 18: The method of any of aspects 11 through 17, further comprising: transmitting, to the network entity, the random access preamble via one or more symbols of a slot within the random access occasion the second set of random access occasions and in accordance with a set of validity rules, wherein the set of validity rules indicate that the slot is valid based at least in part on a quantity of symbols after reception of a SSB of the one or more SSBs and a communication direction associated with the slot.

Aspect 19: The method of any of aspects 11 through 18, further comprising: transmitting, to the network entity, the random access preamble via one or more symbols of a slot within the random access occasion of the second set of random access occasions and in accordance with a set of validity rules, wherein the set of validity rules indicate that the slot is valid based at least in part on a quantity of symbols after reception of a SSB of the one or more SSBs, a communication direction associated with the slot, and whether the slot of the random access occasion is within an uplink sub-band of a full-duplex slot.

Aspect 20: The method of any of aspects 11 through 19, wherein the first set of random access occasions is indicated by the one or more SSBs and a first mapping between the one or more of SSBs and the first set of random access occasions, and wherein the second set of random access occasions is indicated by the one or more of synchronization blocks and a second mapping between the one or more of SSBs and the second set of random access occasions.

Aspect 21: A network entity for wireless communications, comprising one or more memories storing processor-executable code, and one or more processors coupled with the one or more memories and individually or collectively operable to execute the code to cause the network entity to perform a method of any of aspects 1 through 10.

Aspect 22: A network entity for wireless communications, comprising at least one means for performing a method of any of aspects 1 through 10.

Aspect 23: A non-transitory computer-readable medium storing code for wireless communications, the code comprising instructions executable by a processor to perform a method of any of aspects 1 through 10.

Aspect 24: A UE for wireless communications, comprising one or more memories storing processor-executable code, and one or more processors coupled with the one or more memories and individually or collectively operable to execute the code to cause the UE to perform a method of any of aspects 11 through 20.

Aspect 25: A UE for wireless communications, comprising at least one means for performing a method of any of aspects 11 through 20.

Aspect 26: A non-transitory computer-readable medium storing code for wireless communications, the code comprising instructions executable by a processor to perform a method of any of aspects 11 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
transmit a set of synchronization signal blocks that indicate both a first set of random access occasions and a second set of random access occasions different from the first set of random access occasions, the second set of random access occasions associated with full-duplex capable wireless devices;
monitor both the first set of random access occasions and the second set of random access occasions; and
receive, from a user equipment (UE) during a random access occasion, a random access preamble based at least in part on the UE being a full-duplex capable wireless device and based at least in part on the monitoring of the first set of random access occasions and the second set of random access occasions.

2. The network entity of claim 1, wherein, to transmit the set of synchronization signal blocks, the one or more processors are individually or collectively operable to execute the code to cause the network entity to:
transmit system information that indicates the second set of random access occasions associated with the full-duplex capable wireless devices, the system information being transmitted as part of the set of synchronization signal blocks.

3. The network entity of claim 1, wherein the one or more processors are individually or collectively further operable to execute the code to cause the network entity to:
transmit system information that indicates the random access occasion for the full-duplex capable wireless devices to use for transmission of random access preamble transmission, wherein the random access preamble is received from the UE via the random access occasion indicated by the system information.

4. The network entity of claim 1, wherein, to receive the random access preamble, the one or more processors are individually or collectively operable to execute the code to cause the network entity to:
receive, from the UE, the random access preamble during the random access occasion, wherein the random access occasion is of the first set of random access occasions or of the second set of random access occasions.

5. The network entity of claim 1, wherein, to transmit the set of synchronization signal blocks, the one or more processors are individually or collectively operable to execute the code to cause the network entity to:
transmit the set of synchronization signal blocks that indicate the first set of random access occasions and the second set of random access occasions, wherein the second set of random access occasions are offset from the first set of random access occasions in accordance with a time offset, a frequency offset, or both.

6. The network entity of claim 5, wherein the one or more processors are individually or collectively further operable to execute the code to cause the network entity to:
transmit system information that indicates the time offset, the frequency offset, or both.

7. The network entity of claim 1, wherein, to receive the random access preamble, the one or more processors are individually or collectively operable to execute the code to cause the network entity to:
receive, during the random access occasion of the second set of random access occasions, the random access preamble from a first set of random access preambles associated with the full-duplex capable wireless devices, wherein the first set of random access preambles is the same or different from a second set of random access preambles associated with for half-duplex wireless devices.

8. The network entity of claim 1, wherein the one or more processors are individually or collectively further operable to execute the code to cause the network entity to:
receive, from the UE, the random access preamble via one or more symbols of a slot within the random access occasion of the second set of random access occasions and in accordance with a set of validity rules, wherein the set of validity rules indicate that the slot is valid based at least in part on a quantity of symbols after transmission of a synchronization signal block of the set of synchronization signal blocks and a communication direction associated with the slot.

9. The network entity of claim 1, wherein the one or more processors are individually or collectively further operable to execute the code to cause the network entity to:
receive, from the UE, the random access preamble via one or more symbols of a slot within the random access occasion of the second set of random access occasions and in accordance with a set of validity rules, wherein the set of validity rules indicate that the slot is valid based at least in part on a quantity of symbols after transmission of a synchronization signal block of the set of synchronization signal blocks, a communication direction associated with the slot, and whether the slot of the random access occasion is within an uplink sub-band on a full-duplex slot.

10. The network entity of claim 1, wherein the first set of random access occasions is indicated by the set of synchronization signal blocks and a first mapping between the set of synchronization signal blocks and the first set of random access occasions, and wherein the second set of random access occasions is indicated by the set of synchronization signal blocks and a second mapping between the set of synchronization signal blocks and the second set of random access occasions.

11. A user equipment (UE), comprising:
one or more memories storing processor-executable code; and
one or more processors coupled with the one or more memories and individually or collectively operable to execute the code to cause the UE to:
receive one or more synchronization signal blocks that indicate both a first set of random access occasions and a second set of random access occasions different from the first set of random access occasions, the second set of random access occasions associated with full-duplex capable wireless devices; and
transmit, to a network entity, during a random access occasion, a random access preamble based at least in part on the UE being a full-duplex capable wireless device and based at least in part on receiving the one or more synchronization signal blocks indicating the first set of random access occasions and the second set of random access occasions.

12. The UE of claim 11, wherein, to receive the one or more synchronization signal blocks, the one or more processors are individually or collectively operable to execute the code to cause the UE to:
receive, from the network entity, system information that indicates the second set of random access occasions associated with for the full-duplex capable wireless devices, the system information being received based at least in part on receiving of the one or more synchronization signal blocks.

13. The UE of claim 11, wherein the one or more processors are individually or collectively further operable to execute the code to cause the UE to:
receive, from the network entity, system information that indicates the random access occasion of for the UE to use for transmission, wherein the random access preamble is transmitted to the network entity via the random access occasion indicated by the system information.

14. The UE of claim 11, wherein, to transmit the random access preamble, the one or more processors are individually or collectively operable to execute the code to cause the UE to:
transmit the random access preamble during the random access occasion, wherein the random access occasion is of the first set of random access occasions or of the second set of random access occasions.

15. The UE of claim 11, wherein, to receive the one or more synchronization signal blocks, the one or more processors are individually or collectively operable to execute the code to cause the UE to:
receive the one or more synchronization signal blocks that indicate the first set of random access occasions and the second set of random access occasions, wherein the second set of random access occasions are offset from the first set of random access occasions in accordance with a time offset, a frequency offset, or both.

16. The UE of claim 15, wherein the second set of random access occasions are offset from the first set of random access occasions, and the one or more processors are individually or collectively further operable to execute the code to cause the UE to:
receive, from the network entity, system information that indicates the time offset, the frequency offset, or both.

17. The UE of claim 11, wherein, to transmit the random access preamble, the one or more processors are individually or collectively operable to execute the code to cause the UE to:
transmit, during the random access occasion of the second set of random access occasions, the random access preamble from a first set of random access preambles associated with the full-duplex capable wireless devices, wherein the first set of random access preambles is the same or different from a second set of random access preambles associated with half-duplex wireless devices.

18. The UE of claim 11, wherein the one or more processors are individually or collectively further operable to execute the code to cause the UE to:
transmit, to the network entity, the random access preamble via one or more symbols of a slot within the random access occasion the second set of random access occasions and in accordance with a set of validity rules, wherein the set of validity rules indicate that the slot is valid based at least in part on a quantity of symbols after reception of a synchronization signal block of the one or more synchronization signal blocks and a communication direction associated with the slot.

19. The UE of claim 11, wherein the one or more processors are individually or collectively further operable to execute the code to cause the UE to:
transmit, to the network entity, the random access preamble via one or more symbols of a slot within the random access occasion of the second set of random access occasions and in accordance with a set of validity rules, wherein the set of validity rules indicate that the slot is valid based at least in part on a quantity of symbols after reception of a synchronization signal block of the one or more synchronization signal blocks, a communication direction associated with the slot, and whether the slot of the random access occasion is within an uplink sub-band of a full-duplex slot.

20. The UE of claim 11, wherein the first set of random access occasions is indicated by the one or more synchronization signal blocks and a first mapping between the one or more synchronization signal blocks and the first set of random access occasions, and wherein the second set of random access occasions is indicated by the one or more synchronization signal blocks and a second mapping between the one or more synchronization signal blocks and the second set of random access occasions.

21. A method for wireless communications by a network entity, comprising:
transmitting a set of synchronization signal blocks that indicate both a first set of random access occasions and a second set of random access occasions different from the first set of random access occasions, the second set of random access occasions associated with full-duplex capable wireless devices;
monitoring both the first set of random access occasions and the second set of random access occasions; and
receiving, from a user equipment (UE) during a random access occasion, a random access preamble based at least in part on the UE being a full-duplex capable wireless device and based at least in part on the monitoring of the first set of random access occasions and the second set of random access occasions.

22. The method of claim 21, wherein transmitting the set of synchronization signal blocks comprises:
transmitting system information that indicates the second set of random access occasions associated with the full-duplex capable wireless devices, the system information being transmitted as part of the set of synchronization signal blocks.

23. The method of claim 21, wherein receiving the random access preamble comprises:
receiving, from the UE, the random access preamble during the random access occasion, wherein the random access occasion is of the first set of random access occasions or of the second set of random access occasions.

24. The method of claim 21, further comprising:
receiving, from the UE, the random access preamble via one or more symbols of a slot within the random access occasion of the second set of random access occasions and in accordance with a set of validity rules, wherein the set of validity rules indicate that the slot is valid based at least in part on a quantity of symbols after transmission of a synchronization signal block of the set of synchronization signal blocks and a communication direction associated with the slot.

25. The method of claim 21, further comprising:
receiving, from the UE, the random access preamble via one or more symbols of a slot within the random access occasion of the second set of random access occasions and in accordance with a set of validity rules, wherein the set of validity rules indicate that the slot is valid based at least in part on a quantity of symbols after transmission of a synchronization signal block of the set of synchronization signal blocks, a communication direction associated with the slot, and whether the slot of the random access occasion is within an uplink sub-band on a full-duplex slot.

26. A method for wireless communications by a user equipment (UE), comprising:
receiving one or more synchronization signal blocks that indicate both a first set of random access occasions and a second set of random access occasions different from the first set of random access occasions, the second set of random access occasions associated with full-duplex capable wireless devices; and
transmitting, to a network entity, during a random access occasion, a random access preamble based at least in part on the UE being a full-duplex capable wireless device and based at least in part on receiving the one or more synchronization signal blocks indicating the first set of random access occasions and the second set of random access occasions.

27. The method of claim 26, wherein receiving the one or more synchronization signal blocks comprises:
receiving, from the network entity, system information that indicates the second set of random access occasions associated with the full-duplex capable wireless devices, the system information being received based at least in part on receiving of the one or more synchronization signal blocks.

28. The method of claim 26, further comprising:
receiving, from the network entity, system information that indicates the random access occasion of for the UE to use for transmission, wherein the random access preamble is transmitted to the network entity via the random access occasion indicated by the system information.

29. The method of claim 26, further comprising:
transmitting, to the network entity, the random access preamble via one or more symbols of a slot within the random access occasion the second set of random access occasions and in accordance with a set of validity rules, wherein the set of validity rules indicate that the slot is valid based at least in part on a quantity of symbols after reception of a synchronization signal block of the one or more synchronization signal blocks and a communication direction associated with the slot.

30. The method of claim 26, further comprising:
transmitting, to the network entity, the random access preamble via one or more symbols of a slot within the random access occasion of the second set of random access occasions and in accordance with a set of validity rules, wherein the set of validity rules indicate that the slot is valid based at least in part on a quantity of symbols after reception of a synchronization signal block of the one or more synchronization signal blocks, a communication direction associated with the slot, and whether the slot of the random access occasion is within an uplink sub-band of a full-duplex slot.
